(19) United States
(12) Patent Application Publication
(10) Pub. No.: US 2023/0008609 A1
(43) Pub. Date: Jan. 12, 2023

(54) ASSEMBLY ERROR CORRECTION

(71) Applicant: Divergent Technologies, Inc., Los Angeles, CA (US)

(72) Inventors: Lukas Philip Czinger, Santa Monica, CA (US); Keith McKay, Los Angeles, CA (US); Richard Kingston, Los Angeles, CA (US)

(21) Appl. No.: 17/858,933

(22) Filed: Jul. 6, 2022

Related U.S. Application Data
(60) Provisional application No. 63/218,840, filed on Jul. 6, 2021.
(60) Provisional application No. 63/219,323, filed on Jul. 7, 2021.
(60) Provisional application No. 63/222,866, filed on Jul. 16, 2021.

(51) Int. Cl. B25J 9/16

(52) U.S. Cl. CPC B25J 9/1687; B25J 9/1653

(57) ABSTRACT

In the present disclosure, methods, systems, and apparatuses for in-process assembly error correction are described. In various embodiments, a target arrangement of parts of an assembly may be obtained, with the target arrangement including a first target position of a first part, a second target position of a second part, and a third target position of a third part. The first part and the second part may be robotically joined based on the first target position and the second target position to obtain a first subassembly of the assembly, with the first subassembly having a first physical arrangement that includes the physical arrangement of the first and second parts after joining. The first physical arrangement may be fitted to the target arrangement to obtain a fitted first physical arrangement. The first subassembly and the third part may be robotically joined based on the fitted first physical arrangement.

### CROSS-REFERENCE TO RELATED APPLICATIONS

The present disclosure claims the benefit under 35 U.S.C. 119 of U.S. Provisional Patent Application No. 63/218,840, filed Jul. 6, 2021, and entitled “IN-PROCESS ASSEMBLY ERROR CORRECTION”, U.S. Provisional Patent Application No. 63/219,323, filed Jul. 7, 2021, and entitled “IN-PROCESS ASSEMBLY ERROR CORRECTION”, and U.S. Provisional Patent Application No. 63/222,866, filed Jul. 16, 2021, and entitled “IN-PROCESS ASSEMBLY ERROR CORRECTION”, which applications are incorporated by reference herein in their entirety.

### INTRODUCTION

### Field

The present disclosure relates to robots configured for assembly operations, and more specifically to correcting for errors caused by robotic joins during assembly operations.

### BACKGROUND

A transport structure such as an automobile, truck or aircraft may employ a large number of interior and exterior nodes. A node is a structure that may include one or more interfaces used to connect to other spanning components such as tubes, extrusions, panels, other nodes, and the like. Nodes may also be referred to herein as structures or parts. These nodes provide structure to the automobile, truck and aircraft, and respond appropriately to the many different types of forces that are generated or that result from various actions like accelerating and braking. These nodes also provide support. Nodes of varying sizes and geometries may be integrated in a transport structure, for example, to provide an interface between panels, extrusions, and/or other structures.

Most nodes must be coupled to, or interface securely with, another part or structure in secure, well-designed ways. In order to securely connect a node with another part or structure, the node may need to undergo one or more processes in order to prepare the node to connect with the other part or structure. For example, the node may be machined at an interface in order to connect with various other parts or structures. Further examples of processes include surface preparation operations, heat treatment, electrocoating, electroplating, anodization, chemical etching, cleaning, support removal, powder removal, and so forth.

In order to produce a transport structure (e.g., a vehicle, an aircraft, a metro system, etc.), one or more assembly operations may be performed after a node is constructed. For example, a node may be connected with a part, e.g., in order to form a portion of a transport structure (e.g., a vehicle chassis, etc.). Such assembly may involve a degree of accuracy that is within one or more tolerance thresholds of an assembly system, e.g., in order to ensure that the node is securely connected with the part and, therefore, the transport structure may be satisfactorily produced.

When robots (e.g., robotic arms) perform assembly operations, the robots may engage with different parts (e.g., nodes, structures, etc.). Some degree of error is expected when such parts are joined together, as absolute precision is difficult and often cost prohibitive. Thus, a need exists for techniques and approaches to correcting errors that occur during assembly processes.

### SUMMARY

The present disclosure generally relates to assembly operations performed in association with production of transport structures. Such assembly operations may include joining parts (e.g., additively manufactured nodes) to form subassemblies and assemblies. Because transport structures are to be safe, reliable, and so forth, approaches to accurately performing various assembly operations associated with production of transport structures may be beneficial. Such approaches to various assembly operations may be performed by at least one robotic arm that may be instructed via computer-generated instructions. Accordingly, a computer may implement various techniques to generate instructions for at least one robot that causes the at least one robot to correct errors in positioning parts when performing various assembly processes.

In the present disclosure, methods, systems, and apparatuses for in-process assembly error correction are described. In some embodiments, the techniques described herein relate to a method of robotic assembly of parts, the method including: obtaining a target arrangement of the parts of the assembly, wherein the target arrangement includes a first target position of a first part, a second target position of a second part, and a third target position of a third part; robotically joining the first part and the second part based on the first target position and the second target position in the target arrangement to obtain a first subassembly of the assembly, the first subassembly having a first physical arrangement, wherein the first physical arrangement includes the physical arrangement of the first and second parts after joining; fitting the first physical arrangement to the target arrangement to obtain a fitted first physical arrangement; and robotically joining the first subassembly and the third part, wherein the first subassembly is arranged in the fitted first physical arrangement, and the third part is arranged in the third target position in the target arrangement.

In some embodiments, the techniques described herein relate to a method, wherein the target arrangement further includes a fourth target position of a fourth part, and robotically joining the first subassembly and the third part obtains a second subassembly of the assembly, the second subassembly having a second physical arrangement, wherein the second physical arrangement includes the physical arrangement of the first, second, and third parts after joining, the method further including: fitting the second physical arrangement to the target arrangement to obtain a fitted second physical arrangement; and robotically joining the second subassembly and the fourth part, wherein the second subassembly is arranged in the fitted second physical arrangement, and the fourth part is arranged in the fourth target position in the target arrangement.

In some embodiments, the techniques described herein relate to a method, wherein fitting the first physical arrangement to the target arrangement includes performing a best-fit correction.

In some embodiments, the techniques described herein relate to a method, wherein performing the best-fit correction includes determining a difference in position between each of a plurality of corresponding pairs of same features of the first physical arrangement and the target arrangement, and minimizing an error based on the differences in position.

In some embodiments, the techniques described herein relate to a method, wherein minimizing the error includes minimizing a sum of the squares of the differences of position.

In some embodiments, the techniques described herein relate to a method, wherein fitting the first physical arrangement to the target arrangement includes determining a difference between a first join position of the first part and a first target join position of the first part, and determining a second target join position at which to join the third part with the first part based on the difference.

In some embodiments, the techniques described herein relate to a method, further including: determining a set of parts associated with the assembly, wherein the set of parts includes the first part, the second part, and the third part; determining dimensional information of each of the first, second, and third parts, and determining the target arrangement based on the dimensional information.

In some embodiments, the techniques described herein relate to a method, further including: determining, prior to joining the first subassembly and the third part, an interference between the first subassembly and the third part; and adjusting the fitted first physical arrangement if the interference exceeds a threshold.

In some embodiments, the techniques described herein relate to a method, wherein the interference includes a portion of the first subassembly contacting a portion of the third part.

In some embodiments, the techniques described herein relate to a method, wherein the interference is determined further based on a tolerance of a joint between the third part and the first part.

In some embodiments, the techniques described herein relate to a method, further including: measuring a first part position of the first part and a second part position of the second part based on a set of key product characteristics associated with the first part and the second part, wherein fitting the first physical arrangement to the target arrangement is based on the first part position and the second part position.

In some embodiments, the techniques described herein relate to a method, wherein the key product characteristics include at least one of a tolerance associated with a joint included in the assembly, a clearance associated with the assembly, or a surface profile associated with the assembly.

In some embodiments, the techniques described herein relate to a system configured for robotic assembly of parts, including: a computing system configured to obtain a target arrangement of the parts of the assembly, wherein the target arrangement includes a first target position of a first part, a second target position of a second part, and a third target position of a third part; and at least two robots configured to: robotically join the first part and the second part based on the first target position and the second target position in the target arrangement to obtain a first subassembly of the assembly, the first subassembly having a first physical arrangement, wherein the first physical arrangement includes the physical arrangement of the first and second parts after joining, and robotically join the first subassembly and the third part, wherein the first subassembly is arranged in a fitted first physical arrangement, and the third part is arranged in the third target position in the target arrangement, wherein the computing system is further configured to fit the first physical arrangement to the target arrangement to obtain the fitted first physical arrangement.

In some embodiments, the techniques described herein relate to a system, wherein the target arrangement further includes a fourth target position of a fourth part, and the robotic join of the first subassembly and the third part obtains a second subassembly of the assembly, the second subassembly having a second physical arrangement, wherein the second physical arrangement includes the physical arrangement of the first, second, and third parts after joining, the computing system further configured to: fit the second physical arrangement to the target arrangement to obtain a fitted second physical arrangement; and the at least two robots further configured to: robotically join the second subassembly and the fourth part, wherein the second subassembly is arranged in the fitted second physical arrangement, and the fourth part is arranged in the fourth target position in the target arrangement.

In some embodiments, the techniques described herein relate to a system, wherein to fit the first physical arrangement to the target arrangement, the computing system is configured to perform a best-fit correction.

In some embodiments, the techniques described herein relate to a system, wherein to perform the best-fit correction, the computing system is configured to: determine a difference in position between each of a plurality of corresponding pairs of same features of the first physical arrangement and the target arrangement, and minimize an error based on the differences in position.

In some embodiments, the techniques described herein relate to a system, wherein to minimize the error, the computing system is configured to minimize a sum of the squares of the differences of position.

In some embodiments, the techniques described herein relate to a system, wherein to fit the first physical arrangement to the target arrangement, the computing system is configured to: determine a difference between a first join position of the first part and a first target join position of the first part, and determine a second target join position at which to join the third part with the first part based on the difference.

In some embodiments, the techniques described herein relate to a system, wherein the computing system is further configured to: determine a set of parts associated with the assembly, wherein the set of parts includes the first part, the second part, and the third part; determine dimensional information of each of the first, second, and third parts, and determine the target arrangement based on the dimensional information.

In some embodiments, the techniques described herein relate to a system, wherein the computing system is further configured to: determine, prior to joining the first subassembly and the third part, an interference between the first subassembly and the third part; and adjust the fitted first physical arrangement if the interference exceeds a threshold.

In some embodiments, the techniques described herein relate to a system, wherein the interference includes a portion of the first subassembly contacting a portion of the third part.

In some embodiments, the techniques described herein relate to a system, wherein the interference is determined further based on a tolerance of a joint between the third part and the first part.

In some embodiments, the techniques described herein relate to a system, wherein the computing system is further configured to: measure a first part position of the first part and a second part position of the second part based on a set of key product characteristics associated with the first part and the second part, wherein the fit of the first physical arrangement to the target arrangement is based on the first part position and the second part position.

In some embodiments, the techniques described herein relate to a system, wherein the key product characteristics include at least one of a tolerance associated with a joint included in the assembly, a clearance associated with the assembly, or a surface profile associated with the assembly.

It will be understood that other aspects of in-process assembly error corrections, e.g., as performed by computing systems and/or controllers with robots to facilitate various assembly processes of additively manufactured parts, will become readily apparent to those skilled in the art from the following detailed description, wherein it is shown and described only several embodiments by way of illustration. As will be realized by those skilled in the art, the disclosed subject matter is capable of other and different embodiments and its several details are capable of modification in various other respects, all without departing from the invention. Accordingly, the drawings and detailed description are to be regarded as illustrative in nature and not as restrictive.

### BRIEF DESCRIPTION OF THE DRAWINGS

FIG. 1 illustrates an exemplary embodiment of certain aspects of a Direct Metal Deposition (DMD) 3-D printer.

FIG. 2 illustrates a conceptual flow diagram of a 3-D printing process using a 3-D printer.

FIGS. 3A, 3B, 3C, and 3D illustrate exemplary powder bed fusion (PBF) systems during different stages of operation.

FIG. 4 illustrates a perspective view of an example assembly system in which robots perform various assembly processes.

FIG. 5 illustrates a perspective of a target arrangement included in an assembly.

FIG. 6 illustrates a perspective of a physical arrangement of parts with an assembly error after a first join.

FIG. 7 illustrates a perspective of fitting the physical arrangement of parts to the target arrangement of parts after the first join.

FIG. 8 illustrates a perspective of applying a correction to a third part in the target arrangement after fitting the physical arrangement to the target arrangement.

FIG. 9 illustrates a perspective of the physical arrangement of parts with another assembly error after a second join.

FIG. 10 illustrates a perspective of fitting the physical arrangement of parts to the target arrangement of parts after the second join.

FIG. 11 illustrates a perspective of applying a correction to a fourth part in the target arrangement after fitting the physical arrangement to the target arrangement.

FIG. 12 illustrates a perspective of the physical arrangement of parts with still another assembly error after a third join.

FIG. 13 illustrates a perspective of fitting the physical arrangement of parts to the target arrangement of parts after the third join.

FIG. 14 illustrates a method of in-process assembly error correction, according to some embodiments of the present disclosure.

FIG. 15 illustrates another method of in-process assembly error correction according to some other embodiments of the present disclosure.

FIG. 16 illustrates an example of a hardware implementation for an example apparatus.

### DETAILED DESCRIPTION

The detailed description set forth below in connection with the appended drawings is intended to provide a description of various exemplary embodiments and is not intended to represent the only embodiments in which the invention may be practiced. The terms “exemplary,” “illustrative,” and the like used throughout the present disclosure mean “serving as an example, instance, or illustration,” and should not necessarily be construed as preferred or advantageous over other embodiments presented in the present disclosure. The detailed description includes specific details for the purpose of providing a thorough and complete disclosure that fully conveys the scope of the invention to those skilled in the art. However, the invention may be practiced without these specific details. In some instances, well-known structures and components may be shown in block diagram form, or omitted entirely, in order to avoid obscuring the various concepts presented throughout the present disclosure. In addition, the figures may not be drawn to scale and instead may be drawn in a way that attempts to most effectively highlight various features relevant to the subject matter described.

Additive Manufacturing (3-D Printing). Additive manufacturing (AM) is advantageously a non-design specific manufacturing technique. AM provides the ability to create complex structures within a part. For example, nodes can be produced using AM. A node is a structure that may include one or more interfaces used to connect to other spanning components such as tubes, extrusions, panels, other nodes, and the like. Using AM, a node may be constructed to include additional features and functions, depending on the objectives. In various embodiments, nodes may include tongues and/or grooves to be assembled with tongue-and-groove connections. The tongue-and-groove connections may be bonded by an adhesive. For example, an adhesive may be dispensed into the groove of one node, and the tongue of another node made be inserted into the adhesive-filled groove. In various embodiments, a node may be printed with one or more ports that provide a fluid pathway to a groove, so that the node can be bonded to another node by injecting an adhesive into the port to fill the groove of the node after the tongue of other node has been inserted into the groove. In various embodiments, some components may be connected to a node using a brazing slurry, a thermoplastic, a thermoset, or another connection feature, any of which can be used interchangeably in place of an adhesive. Thus, while welding techniques may be suitable with respect to certain embodiments, additive manufacturing provides significant flexibility in enabling the use of alternative or additional connection techniques.

A variety of different AM techniques have been used to 3-D print components composed of various types of materials. Numerous available techniques exist, and more are being developed. For example, Directed Energy Deposition (DED) AM systems use directed energy sourced from laser or electron beams to melt metal. These systems utilize both powder and wire feeds. The wire feed systems advantageously have higher deposition rates than other prominent AM techniques. Single Pass Jetting (SPJ) combines two powder spreaders and a single print unit to spread metal powder and to print a structure in a single pass with little or no wasted motion. As another illustration, electron beam additive manufacturing processes use an electron beam to fuse metal via wire feedstock or sintering on a powder bed in a vacuum chamber. Atomic Diffusion Additive Manufacturing (ADAM) is still another recently developed technology in which components are printed, layer-by-layer, using a metal powder in a plastic binder. After printing, plastic binders are removed and the entire part (e.g., structure) is sintered at once into a desired metal.

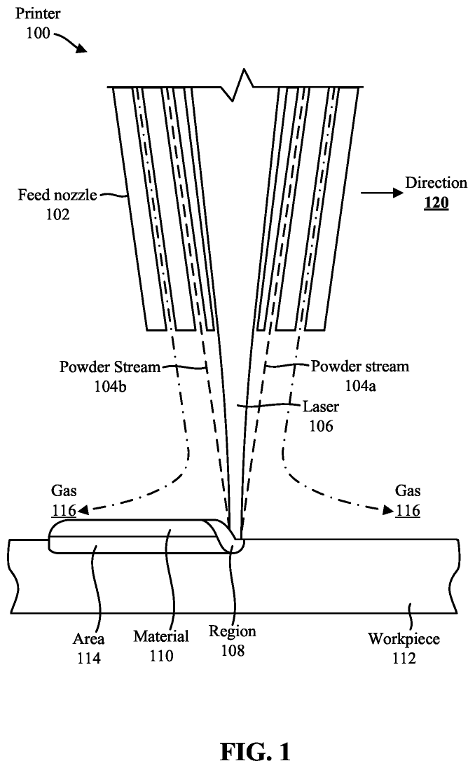

One of several such AM techniques, as noted, is DMD. FIG. 1 illustrates an example embodiment of certain aspects of a DMD 3-D printer 100. DMD printer 100 uses a feed nozzle 102 moving in a predefined direction 120 to propel powder streams 104a and 104b into a laser beam 106, which is directed toward a workpiece 112 that may be supported by a substrate. Feed nozzle may also include mechanisms for streaming a shield gas 116 to protect the welded area from oxygen, water vapor, or other components.

The powdered metal is then fused by the laser beam 106 in a melt pool region 108, which may then bond to the workpiece 112 as a region of deposited material 110. A dilution area 114 may include a region of the workpiece where the deposited powder is integrated with the local material of the workpiece. Feed nozzle 102 may be supported by a computer numerical controlled (CNC) robot or a gantry, or other computer-controlled mechanism. Feed nozzle 102 may be moved under computer control multiple times along a predetermined direction of the substrate until an initial layer of the deposited material 110 is formed over a desired area of workpiece 112. Feed nozzle 102 can then scan the region immediately above the prior layer to deposit successive layers until the desired structure is formed. In general, feed nozzle 102 may be configured to move with respect to all three axes, and in some instances to rotate on its own axis by a predetermined amount.

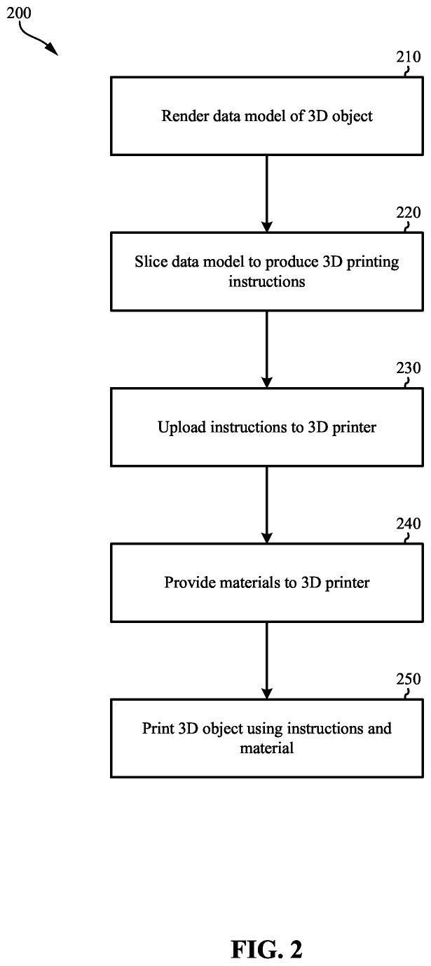

FIG. 2 is a flow diagram illustrating an example method 200 of 3-D printing. A data model of the desired 3-D object to be printed is rendered (200). A data model is a virtual design of the 3-D object. Thus, the data model may reflect the geometrical and structural features of the 3-D object, as well as its material composition. The data model may be created using a variety of methods, including computer-aided engineering (CAE) based optimization, 3-D modeling, photogrammetry software, and camera imaging. CAE-based optimization may include, for example, cloud-based optimization, fatigue analysis, linear or non-linear finite element analysis (FEA), and durability analysis.

3-D modeling software, in turn, may include one of numerous commercially available 3-D modeling software applications. Data models may be rendered using a suitable computer-aided design (CAD) package (210), for example in an STL format. STL is one example of a file format associated with commercially available stereolithography-based CAD software. A CAD program may be used to create the data model of the 3-D object as an STL file. Thereupon, the STL file may undergo a process whereby errors in the file are identified and resolved.

Following error resolution, the data model can be “sliced” (220) by a software application known as a slicer to thereby produce a set of instructions for 3-D printing the object, with the instructions being compatible and associated with the particular 3-D printing technology to be utilized. Numerous slicer programs are commercially available. Generally, the slicer program converts the data model into a series of individual layers representing thin slices (e.g., 100 microns thick) of the object be printed, along with a file containing the printer-specific instructions for 3-D printing these successive individual layers to produce an actual 3-D printed representation of the data model.

The layers associated with 3-D printers and related print instructions need not be planar or identical in thickness. For example, in some embodiments depending on factors like the technical sophistication of the 3-D printing equipment and the specific manufacturing objectives, etc., the layers in a 3-D printed structure may be non-planar and/or may vary in one or more instances with respect to their individual thicknesses.

A common type of file used for slicing data models into layers is a G-code file, which is a numerical control programming language that includes instructions for 3-D printing the object. The G-code file, or other file constituting the instructions, is uploaded (230) to the 3-D printer. Because the file containing these instructions is typically configured to be operable with a specific 3-D printing process, it will be appreciated that many formats of the instruction file are possible depending on the 3-D printing technology used.

In addition to the printing instructions that dictate what and how an object is to be printed, the appropriate physical materials necessary for use by the 3-D printer in printing the object are provided (240) to the 3-D printer using any of several conventional and often printer-specific methods. In DMD techniques, for example, one or more metal powders may be provided for layering structures with such metals or metal alloys. In selective laser melting (SLM), selective laser sintering (SLS), and other PBF-based AM methods (see below), the materials may be provided as powders into chambers that feed the powders to a build platform. Depending on the 3-D printer, other techniques for providing printing materials may be used.

The respective data slices of the 3-D object are then printed (250) based on the provided instructions using the material(s). In 3-D printers that use laser sintering, a laser scans a powder bed and melts the powder together where structure is desired, and avoids scanning areas where the sliced data indicates that nothing is to be printed. This process may be repeated thousands of times until the desired structure is formed, after which the printed part (e.g., structure, node, etc.) is removed from the printer. In fused deposition modelling, as described above, parts are printed by applying successive layers of model and support materials to a substrate. In general, any suitable 3-D printing technology may be employed for purposes of the present disclosure.

Another AM technique is powder-bed fusion (PBF). Like DMD, PBF creates “build pieces” layer-by-layer. Each layer or “slice” is formed by depositing a layer of powder and exposing portions of the powder to an energy beam. The energy beam is applied to melt areas of the powder layer that coincide with the cross-section of the build piece in the layer. The melted powder cools and fuses to form a slice of the build piece. The process can be repeated to form the next slice of the build piece, and so on. Each layer is deposited on top of the previous layer. The resulting structure is a build piece assembled slice-by-slice from the ground up.

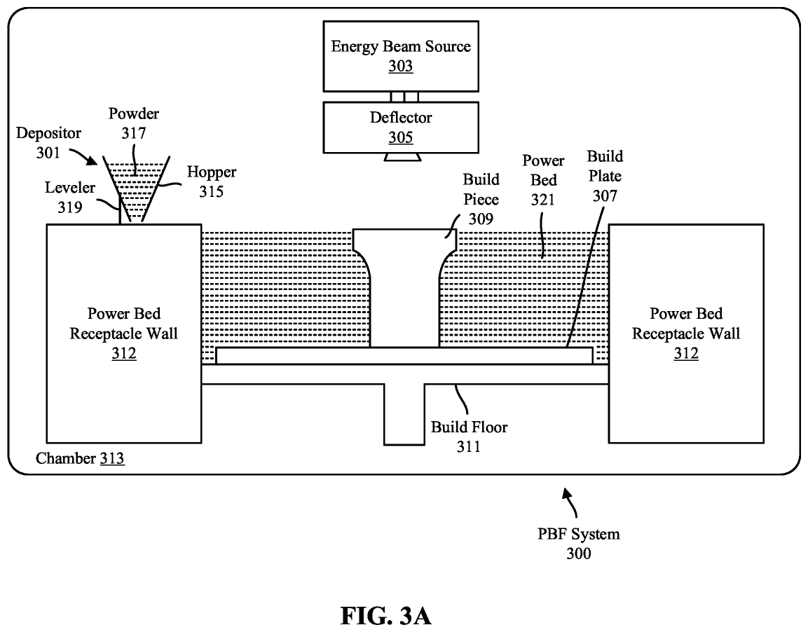

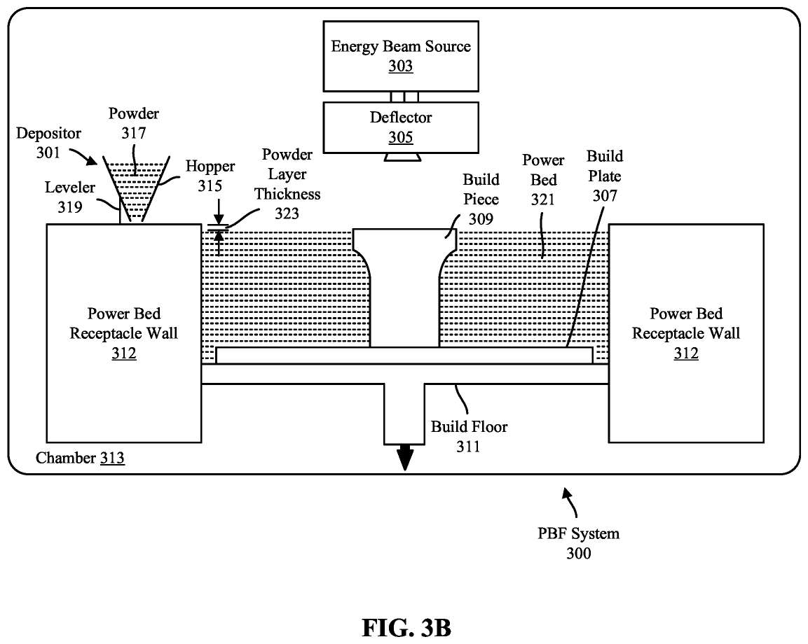

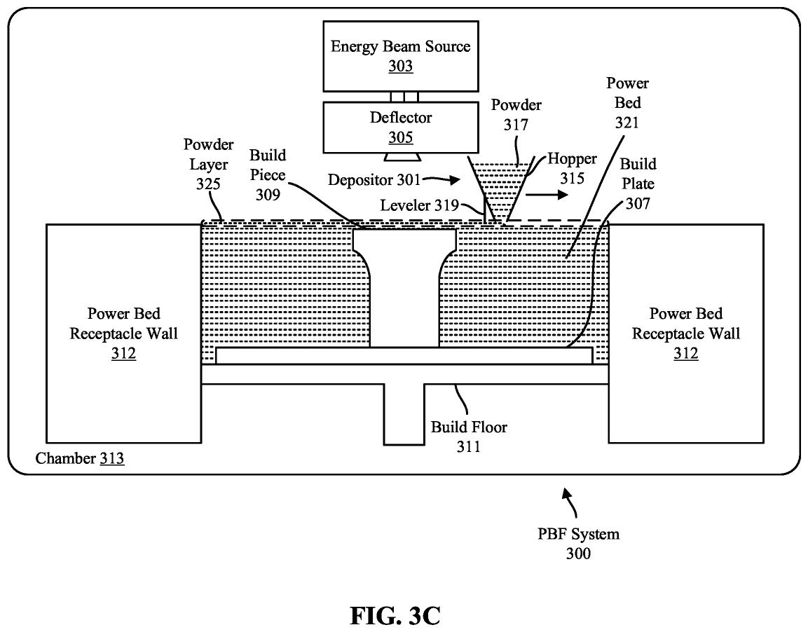

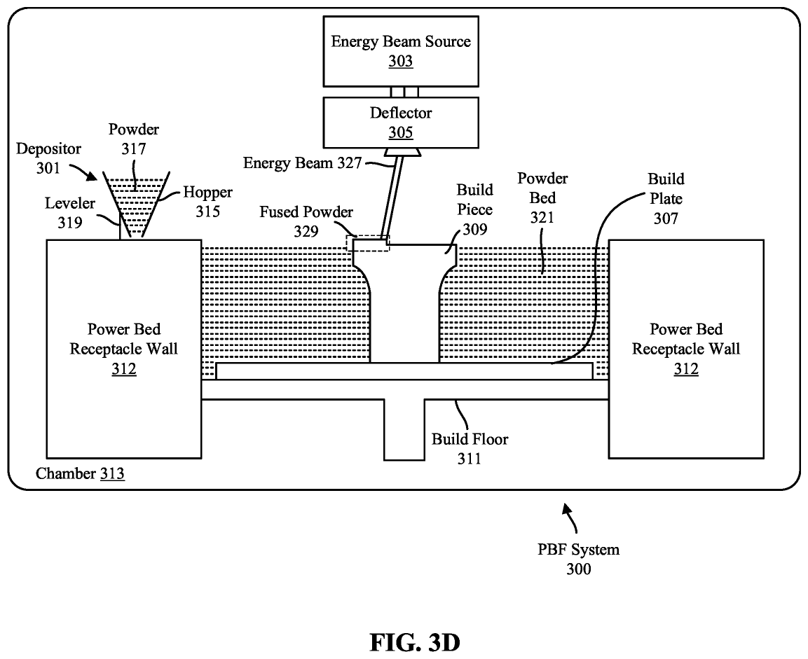

FIGS. 3A-D illustrate respective side views of an example PBF system 300 during different stages of operation. As noted above, the particular embodiment illustrated in FIGS. 3A-D is one of many suitable examples of a PBF system acceptable for use in the present disclosure. It should also be noted that elements of FIGS. 3A-D and the other figures in the present disclosure are not necessarily drawn to scale, but may be drawn larger or smaller for the purpose of better illustration of concepts described herein. PBF system 300 can include a depositor 301 that can deposit each layer of metal powder, an energy beam source 303 that can generate an energy beam, a deflector 305 that can apply the energy beam to fuse the powder, and a build plate 307 that can support one or more build pieces, such as a build piece 309. PBF system 300 can also include a build floor 311 positioned within a powder bed receptacle. Walls 312 of the powder bed receptacle generally define the boundaries of the powder bed receptacle, which is sandwiched between walls 312 from the side and abuts a portion of build floor 311 below. Build floor 311 can progressively lower build plate 307 so that depositor 301 can deposit a next layer. The entire mechanism may reside in a chamber 313 that can enclose the other components, thereby protecting the equipment, enabling atmospheric and temperature regulation and mitigating contamination risks. Depositor 301 can include a hopper 315 that contains a powder 317, such as a metal powder, and a leveler 319 that can level the top of each layer of deposited powder.

Referring specifically to FIG. 3A, an example embodiment shows PBF system 300 after a slice of build piece 309 has been fused, but before the next layer of powder has been deposited. In fact, FIG. 3A illustrates a time at which PBF system 300 has already deposited and fused slices in multiple layers, e.g., 150 layers, to form the current state of build piece 309, e.g., formed of 150 slices. The multiple layers already deposited have created a powder bed 321, which includes powder that was deposited but not fused.

FIG. 3B shows an example embodiment of a PBF system 300 at a stage in which build floor 311 can lower by a powder layer thickness 323. The lowering of build floor 311 causes build piece 309 and powder bed 321 to drop by powder layer thickness 323, so that the top of build piece 309 and powder bed 321 are lower than the top of powder bed receptacle wall 312 by an amount equal to powder layer thickness 323. In this way, for example, a space with a consistent thickness equal to powder layer thickness 323 can be created over the tops of build piece 309 and powder bed 321.

FIG. 3C shows an example embodiment of a PBF system 300 at a stage in which depositor 301 is positioned to deposit powder 317 in a space created over the top surfaces of build piece 309 and powder bed 321 and bounded by powder bed receptacle walls 312. In this example, depositor 301 progressively moves over the defined space while releasing powder 317 from hopper 315. Leveler 319 can level the released powder to form a powder layer 325 that has a thickness substantially equal to powder layer thickness 323 (as shown in FIG. 3B above). Thus, the powder in a PBF system can be supported by a powder support structure, which can include, for example, build plate 307, build floor 311, build piece 309, walls 312, and the like. It should be noted that the illustrated thickness of powder layer 325 (i.e., powder layer thickness 323 (FIG. 3B)) is greater than an actual thickness used for the example involving 150 previously-deposited layers, discussed above with reference to FIG. 3A.

FIG. 3D shows an example embodiment of a PBF system 300 at a stage in which, following the deposition of powder layer 325 (FIG. 3C), energy beam source 303 generates an energy beam 327 and deflector 305 applies the energy beam to fuse powder 329, and so create the next slice in build piece 309. In various example embodiments, energy beam source 303 can be an electron beam source, in which case energy beam 327 constitutes an electron beam. Deflector 305 can include deflection plates that can generate an electric field or a magnetic field that selectively deflects the electron beam to cause the electron beam to scan across areas designated to be fused. In various embodiments, energy beam source 303 can be a laser, in which case energy beam 327 is a laser beam. Deflector 305 can include an optical system that uses reflection and/or refraction to manipulate the laser beam to scan selected areas to be fused.

In various embodiments, deflector 305 can include one or more gimbals and actuators that can rotate and/or translate the energy beam source to position the energy beam. In various embodiments, energy beam source 303 and/or deflector 305 can modulate the energy beam, e.g., turn the energy beam on and off as the deflector scans so that the energy beam is applied only in the appropriate areas of the powder layer. For example, in various embodiments, the energy beam can be modulated by a digital signal processor (DSP).

The present disclosure provides various different embodiments of in-process assembly error correction, which may be connected with a robot for assembly processes, including pre- and/or post-processing operations. It will be appreciated that various embodiments described herein may be practiced together. For example, an embodiment described with respect to one illustration of the present disclosure may be implemented in another embodiment described with respect to another illustration of the present disclosure.

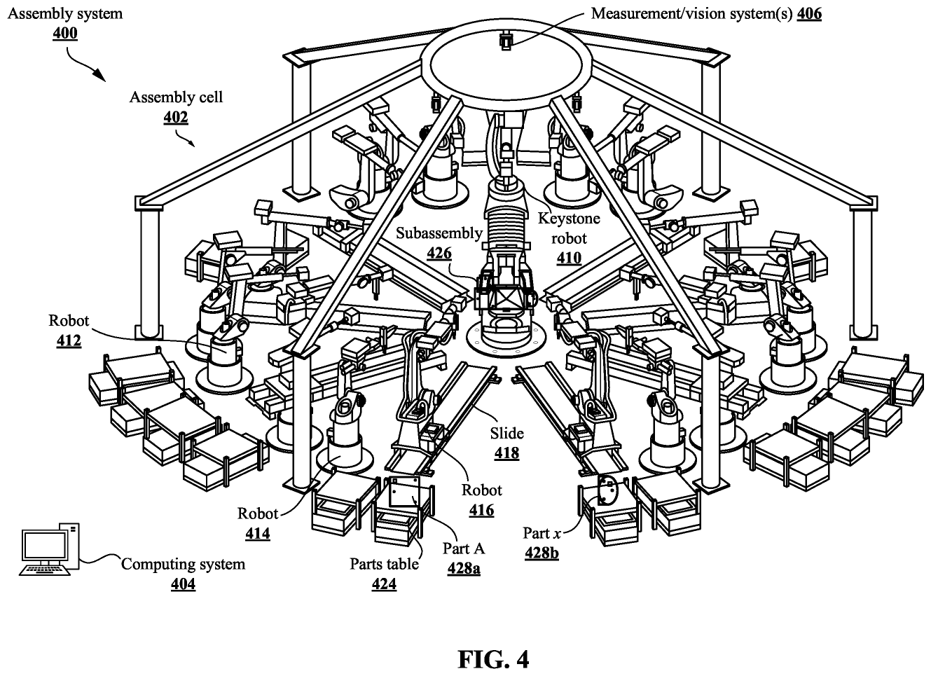

FIG. 4 illustrates a perspective view of an exemplary assembly system 400. In assembly system 400. Assembly system 400 may be employed in various operations associated with assembly of a vehicle, such as robotic assembly of a node-based vehicle. Assembly system 400 may include one or more elements associated with at least a portion of the assembly of a vehicle without any fixtures. For example, one or more elements of assembly system 400 may be configured for one or more operations in which a first part is joined with one or more other parts without the use of any fixtures during robotic assembly of a node-based vehicle.

An assembly cell 402 may be configured at the location of assembly system 400. Within assembly cell 402, fixtureless assembly system 400 may include a set of robots. A robot 410 that is positioned relatively at the center of assembly cell 402 may be referred to as a “keystone robot.” In some embodiments, keystone robot 410 may be positioned at an approximate center point of assembly cell 402.

Assembly system 400 may include one or more parts tables 424 that can hold for the robots to access. Parts tables 424 may be positioned at a periphery or outside of assembly cell 402. For example, parts tables 424 may be radially positioned around approximately the outer boundary of assembly cell 402.

Each of parts tables 424 may hold any number of parts (e.g., from as few as one part to more than twenty parts), and may be designed so as to provide access to one or more of the parts at different stages of the assembly process. In some embodiments, one or more of parts tables 424 may be restocked during the assembly process. For example, new parts may be added to one or more of parts tables 424 in anticipation of future assembly operations as some other assembly operations are occurring.

Illustratively, part A 428a through part x 428b may be positioned on parts tables 424 to be picked up by the robots and assembled together. In various embodiments, each of the parts can weigh at least 10 grams (g), 400 g, 500 g, 1 kilograms (kg), 5 kg, 10 kg, or more. In various embodiments, each of the parts can have a volume of at least 10 milliliter (ml), 400 ml, 500 ml, 4000 ml, 5000 ml, 10,000 ml, or more. In various embodiments, one or more of the parts can be an additively manufactured structure, such as a complex node.

Assembly system 400 may also include a computing system 404 to issue commands to the various controllers of the robots of assembly cell 402. In this example, computing system 404 is communicatively connected to the robots through a wireless communication, although wired connections are also possible. Assembly system 400 may also include a measurement/vision system(s) 406 able to accurately detect and measure the positions of the robotic arms of the robots and/or the parts held by the robots. For example, parts A 428a and x 428b may include one or more metrology features from which the position of a part can be measured when detected (e.g., by a laser or other vision system).

In some embodiments, measurement/vision system(s) 406 may communicate with computing system 404, e.g., to provide data for in-process assembly error corrections in which computing system 404 may provide instructions to the controllers of the robots. In one example assembly system, measurement/vision system(s) 406 can be mounted in a central location above assembly cell 402. In various embodiments, some or all of measurement/vision system(s) 406 may be located, for example, near the perimeter of the assembly cell. Multiple measurement and/or vision systems can be used in various embodiments, and can be located at various locations within or outside the assembly cell. In other example assembly systems, one or more measurement/vision system(s)s and/or metrology devices can be mounted on one or more of the robots 410, 412, 414, 416.

In contrast to conventional robotic assembly factories, parts can be assembled (e.g., into assemblies or subassemblies) without fixtures in assembly system 400. For example, parts need not be connected within any fixtures. Instead, at least one of the robots in assembly cell 402 may provide the functionality expected from fixtures. For example, robots may be configured to directly contact (e.g., using an end effector of a robotic arm) parts to be assembled within assembly cell 402 so that those parts may be engaged and retained without any fixtures. Further, at least one of the robots may provide the functionality expected from the positioner and/or fixture table. For example, keystone robot 410 may replace a positioner and/or fixture table in assembly cell 402.

Keystone robot 410 may include a base and a robotic arm. The robotic arm may be configured for movement, which may be directed by a controller communicatively connected with keystone robot 410 (e.g., computer-executable instructions loaded into a processor of the controller). Keystone robot 410 may contact a surface of assembly cell 402 (e.g., a floor of the assembly cell) through the base.

Keystone robot 410 may include and/or be connected with an end effector that is configured to engage and retain a subassembly 426, e.g., a portion of a vehicle or other build piece, one or more parts that have been joined, one or more nodes, one or more structures, etc. An end effector may be a component configured to interface with at least one part. Examples of the end effectors may include jaws, grippers, pins, or other similar components capable of facilitating fixtureless engagement and retention of a part by a robot. Subassembly 426 may be a section of a vehicle chassis, body, frame, panel, base piece, and the like. For example, subassembly 426 may comprise a floor panel. In some embodiments, subassembly 426 may be referred to as an “assembly.”

In some embodiments, keystone robot 410 may retain the connection with subassembly 426 through an end effector while a set of other parts is connected (either directly or indirectly) to subassembly 426. Keystone robot 410 may be configured to engage and retain subassembly 426 without any fixtures. In some embodiments, assemblies (and subassemblies) to be retained by at least one of the robots (e.g., subassembly 426) may be additively manufactured or co-printed with one or more features that facilitate engagement and retention of those parts by the at least one of the robots without the use of any fixtures.

For example, a part may be co-printed or additively manufactured with one or more features that increase the strength of the part, such as a mesh, honeycomb, and/or lattice arrangement. Such features may stiffen the part to prevent unintended movement of the part during the assembly process. In another example, a part may be co-printed or additively manufactured with one or more features that facilitates engagement and retention of the part by an end effector, such as protrusion(s) and/or recess(es) suitable to be engaged (e.g., gripped, clamped, held, etc.) by an end effector. The aforementioned features of a part may be co-printed with the part and may be of the same material(s) as the part.

In retaining subassembly 426, keystone robot 410 may position (e.g., move) subassembly 426; that is, the position of subassembly 426 may be controlled by keystone robot 410 when retained thereby. Keystone robot 410 may retain the first part by “holding” or “grasping” subassembly 426, e.g., using an end effector of a robotic arm of keystone robot 410. For example, keystone robot 410 may retain the first part by causing gripper fingers, jaws, and the like to contact one or more surfaces of the first part and apply sufficient pressure thereto such that the keystone robot controls the position of subassembly 426. That is, subassembly 426 may be prevented from moving freely in space when retained by keystone robot 410, and movement of subassembly 426 may be constrained by keystone robot 410. As described above, subassembly 426 may include one or more features that facilitates engagement and retention of subassembly 426 by keystone robot 410 without the use of any fixtures.

As other parts (including subassemblies, structures, substructures of structures, etc.) are connected to subassembly 426, keystone robot 410 may retain the engagement with subassembly 426 through the end effector. The aggregate of subassembly 426 and one or more parts connected thereto may be referred to as an assembly or subassembly itself, but may also be referred to as a “structure” or a “substructure.” Keystone robot 410 may retain an engagement with an assembly once keystone robot 410 has engaged subassembly 426.

As illustrated, assembly system 400 further includes robots 412, 414, 416 positioned in assembly cell 402, in addition to keystone robot 410. Assembly cell 402 may feature a radial architecture, in that robots 412, 414, 416 may be positioned in assembly cell 402 around a common point (e.g., keystone robot 410 and/or the center of assembly cell 402). For example, robots 412, 414, 416 may be arranged in at least two concentric circles (or other concentric polygons), with a first set of robots 412, 414 positioned in a first configuration around a common point (e.g., keystone robot 410) and a second set of robots 416 positioned in a second configuration around the common point.

The architecture of assembly cell 402 (e.g., including spacing between robots 412, 414, 416 and positions of robots 412, 414, 416) may be based on an average part to be assembled, such as a body-in-white (BIW) vehicle or a vehicle chassis, and/or may be based on the fixtureless assembly process of assembly system 400. For example, the layout of assembly cell 402 may be beneficial and/or may improve over a conventional assembly line in terms of assembly cycle time, cost, performance, robot utilization, and/or flexibility.

Within assembly cell 402, the robots may be variably spaced. Specifically, some robots 416 may be configured on a respective one of slides 418, which may allow those robots 416 to change position (thereby changing robot spacing). That is, each of robots 416 on a respective one of slides 418 may move toward or away from keystone robot 410, e.g., allowing multiple different robot interactions for joining and/or adhesion.

Some robots 412, 416 in assembly cell 402 may be similar to keystone robot 410 in that each includes a respective end effector configured to engage with parts, such as parts that may be connected with subassembly 426 when retained by keystone robot 410. In some embodiments, robots 412, 416 may be referred to with “assembly” and/or “material handling.”

In some embodiments, some robots 414 of assembly cell 402 may be used to effect a structural connection between parts. Such robots 414 may be referred to with “structural adhesive” or “adhesive.” Structural adhesive robots 414 may be similar to keystone robot 410, except a tool may be included at the distal end of the robotic arm that is configured to apply structural adhesive to at least one surface of fixturelessly retained parts, e.g., either before or after the parts are positioned at joining proximities with respect to other parts for joining with the other parts. The joining proximity can be a position that allows a first part to be joined to a second part. For example, in various embodiments, the first and second parts may be joined though the application of an adhesive while the parts are within the joining proximity and subsequent curing of the adhesive.

Potentially, the duration for structural adhesives to cure may be relatively long. If this is the case, the robots retaining the joined parts, for example, might have to hold the parts at the joining proximity for an appreciable duration in order for the parts to be joined by the structural adhesive once it finally cures. This would prevent the robots from being used for other tasks, such as continuing to pick up and assemble parts, for a long time while the structural adhesive cures. In order to allow more efficient use of the robots, for example, in various embodiments a quick-cure adhesive may be additionally used to join the parts quickly and retain the parts so that the structural adhesive can cure without requiring both robots to hold the parts in place.

In this regard, some robots 414, 416 in assembly cell 402 may be used to apply quick-cure adhesive and/or to cure the quick-cure adhesive. In some embodiments, a quick-cure UV adhesive may be used, and the robots may be referred to with “UV.” The UV robots may be similar to keystone robot 410, except a tool may be included at the distal end of the robotic arm that is configured to apply a quick-cure UV adhesive and/or cure the adhesive, e.g., when one part is positioned within the joining proximity with respect to another part. For example, the UV robots may include a respective tool configured to apply UV adhesive and to emit UV light to cure the UV adhesive. In effect, the UV robots may cure an adhesive after the adhesive is applied to one or both parts when the parts are within the joining proximity.

In some embodiments, the quick-cure adhesive applied by a UV robot may provide a partial adhesive bond in that the adhesive may retain the relative positions of parts within a joining proximity until the structural adhesive may be applied and/or cured to permanently join the parts. After the structural adhesive permanently joins the parts, the adhesive providing the partial adhesive bond may be removed (e.g., as with temporary adhesives) or may not be removed (e.g., as with complementary adhesives).

In various embodiments, some robots 414, 416 may be used for multiple different roles. For example, robots 414 may perform the roles of a structural adhesive robot and a UV robot. In this regard, each of robots 414 may be referred to as a “structural adhesive/UV robot.” Each of structural adhesive/UV robots 414 may offer functionality of a structural adhesive robot when configured with a tool to apply structural adhesive, but may offer functionality of a UV robot when configured with a tool to apply and/or cure quick-cure adhesive. Structural adhesive/UV robots 414 may be configured to switch between tools and/or reconfigure a tool in order to perform the relevant task during assembly operations.

Similarly, robots 416 may perform the roles of a material handling robot and a UV robot. Accordingly, each of robots 416 may be referred to as a “material handling/UV robot.” Each of material handling/UV robots 416 may provide the functionality of a material handling robot when configured with an end effector for fixtureless retention of a part, and may also provide the functionality of a UV robot when configured with a tool to apply and/or cure quick-cure adhesive. As with structural adhesive/UV robots 414, material handling/UV robots 416 may be configured to switch between tools and/or reconfigure a tool in order to perform different operations at different times.

In assembly system 400, at least one surface of a part to which adhesive is to be applied may be determined based on gravity and/or other forces that cause loads to be applied on various parts and/or connections of the assembly. Finite element method (FEM) analyses may be used to determine the at least one surface of the part, as well as one or more discrete areas on the at least one surface, to which the adhesive is to be applied. For example, FEM analyses may indicate one or more connections of a structural assembly that may be unlikely or unable to support sections of the structural assembly disposed about the one or more connections.

In assembling at least a portion of a vehicle in assembly cell 402, one part may be joined directly to another part by directing the various robots 412, 414, 416, as described herein. However, additional parts may be indirectly joined to one part. For example, one part may be directly joined to another part through movement(s) of material handling robots 412, structural adhesive/UV robots 414, and material handling/UV robots 416. Thereafter, one part may be indirectly joined to an additional part as the additional part is directly joined to the other part, for example, through movement(s) that additionally include keystone robot 410. Thus, subassemblies may evolve throughout an assembly process as additional parts are directly or indirectly joined to it.

In some embodiments, robots 412, 414, 416 may fixturelessly join two or more parts together, e.g., with a partial, quick-cure adhesive bond, before fixturelessly joining those two or more parts with a part(s) retained by keystone robot 410. The two or more parts that are joined to one another prior to being joined with subassembly 426 may also be a subassembly (or an assembly). Accordingly, when a part forms a portion of a structural subassembly that is connected with subassembly 426 through movements of one or more robots 410, 412, 414, 416, a part of the structural subassembly may be indirectly connected to subassembly 426 when the structural subassembly is joined to subassembly 426.

In some embodiments, the structural adhesive may be applied (e.g., deposited in a groove of one of the parts) before two parts are brought within the joining proximity. For example, one of structural adhesive/UV robots 414 may include a dispenser for dispensing a structural adhesive, and may apply the structural adhesive prior to the parts being brought within the joining proximity.

In some other embodiments, a structural adhesive may be applied after a structural assembly is fully constructed. For example, the structural adhesive may be applied to one or more joints or other connections between parts. The structural adhesive may be applied at a time after the last adhesive curing is performed. In some embodiments, the structural adhesive may be applied separately from assembly system 400.

After the assembly is complete (e.g., after all of the parts have been joined, retained with a partial adhesive bond, and with structural adhesive having been applied), the structural adhesive may be cured. Upon curing the structural adhesive, the portion of the vehicle may be completed and, therefore, may be suitable for use in the vehicle. For example, the assembly may be a body-in-white (BIW) vehicle. A completed structural assembly may meet any applicable industry and/or safety standards defined for consumer and/or commercial vehicles. In some embodiments, the adhesive applied to achieve the partial adhesive bond for retaining parts may be removed, for example, after the structural adhesive is cured. In some other embodiments, the adhesive for the partial adhesive bond may be left attached to the parts.

In order to provide the robots with a set of instructions that achieves the desired subassembly (or assembly), computing system 404 may model a target arrangement of parts. The target arrangement of parts may be a CAD model or the like that indicates positioning information (e.g., coordinates) for joining the parts 428a, 428b at respective target positions to form subassembly 426.

In some embodiments, the target arrangement may be based on data received from measurement/vision system(s) 406. According to various embodiments, measurement/vision system(s) 406 may include one or more cameras, such as a photography camera, a video camera, etc., and/or another system suitable for collecting imaging data in an assembly cell (e.g., imaging data indicative of a part's position). In some other embodiments, measurement/vision system(s) 406 may include one or more of a laser guidance system, laser sensor(s), optical sensor(s), tracker-machine control (T-MAC) sensor(s), and the like.

Measurement/vision system(s) 406 may include a metrology and/or scanning system (e.g., 3-D scanning system, laser scanning system, etc.), a radar system, a laser imaging, detection, and ranging (LIDAR) system (sometimes referred to as a “light detection and ranging” system), and/or another system suitable for collecting imaging data indicative of a part's position. To that end, measurement/vision system(s) 406 may include one or more sensors, such as an optical sensor, a laser sensor, an infrared sensor, a triangulation sensor, a T-MAC sensor, and so forth. Potentially, measurement/vision system(s) 406 may be implemented as a single component, which may have multiple sensors.

Measurement/vision system(s) 406 may be configured to capture data that computing system 404 may use to drive movement of one or more robots that are used to join part to form subassembly 426. For example, measurement/vision system(s) 406 may facilitate the positioning (e.g., moving, rotating, orienting, etc.) of a part in an assembly cell, such as by moving the part to a position at which it may be joined with another part.

In some embodiments, measurement/vision system(s) 406 may capture imaging data indicative of a part's position (e.g., location, orientation, etc.). Such imaging data indicative of a part's position may be used to find a part's position in an absolute coordinate system (e.g., a geographic coordinate system, a bounded coordinate system, etc.) and/or a relative position (e.g., relative to another part with which the part is to be joined, relative to one or more markers from which a position of the part can be derived, etc.).

Measurement/vision system(s) 406 may be configured to provide information indicative of a part's position and/or orientation to computing system 404. Computing system 404 may process the received information, such as by identification and/or extraction (e.g., feature extraction) of information (e.g., metrology features) from which the computing system is able to determine the type of part, the size of the part, the orientation of the part, the location of the part, and/or other similar information. Based on such information, the computing system may generate instructions that drive movement of the robot.

In various embodiments, measurement/vision system(s) 406 may capture information indicative of another part's location, size, orientation etc. For example, measurement/vision system(s) 406 may capture imaging data of a targeted part with another part is to be joined, and computing system 404 may process the received imaging data, such as by determining the orientation of the targeted part, the location of the targeted part, the features with which to join the part with the targeted part, and/or other similar information. Based on such information, computing system 404 may generate instructions that drive movement of the robot in a way that enables joining the part with the targeted part.

Measurement/vision system(s) 406 may capture metrology data indicative of various measurements in an assembly cell. For example, measurement/vision system(s) 406 may capture metrology data representing a key product characteristic (KPC) 1 indicative of a size of a clearance to reach a targeted part, a distance from a potential obstruction, a machining pad on the subassembly, a distance from a targeted part with which a retained part is to be joined, and/or other such data that may be used in joining a part with a transport structure in an assembly cell. A KPC can be, for example, a feature of the assembly whose positional accuracy is of greater importance than other areas of the assembly. For example, a KPC may be an area of an assembly (e.g., an attachment point) that must fit or match with a part to be added after the assembly is complete. For example, a vehicle frame assembly might have various points (e.g., attachment points, “hard points”) to which other structures may later be attached, for example, engine mounts, suspension links, etc. Because the accuracy of dimensional position may be of higher importance for KPCs, in various embodiments, the correction (e.g., fitting) described herein may be based on KPC positions.

In some embodiments, measurement/vision system(s) 406 may be utilized in an in-process assembly error correction procedure in which deviations in the physical arrangement from the target arrangement are corrected for in order to suitably join parts at acceptable locations. For example, joining parts A 428a and x 428b may involve a degree of error that causes one or both part A 428a and part x 428b to deviate from their respective target positions in the target arrangement. The deviations can be measured (e.g., using measurement/vision system(s) 406), and computing system 404 may fit the physical arrangement (e.g., as measured) to the target arrangement to obtain a fitted arrangement. The computing system 404 may update the location (e.g., coordinates) of a subassembly to which a next part is to be connected, and the computing system may commensurately adjust the location (e.g., coordinates) at which the next part is brought to be joined to the subassembly. The computing system 404 may issue instructions to the appropriate robots to join the next part to the subassembly according to the fitted arrangement.

Accordingly, the present disclosure describes process for an assembly system to reduce dimensional errors observed while the assembly process is underway. This in-process assembly error correction includes measuring the dimensional errors of an assembly after each new part is joined thereto, computing a correction for the measured assembly error based on fitting the physical arrangement to the target arrangement, and applying the correction to the position of a subsequent part that is to be joined to the assembly using both the fitted physical arrangement of the already-assembled parts and the target arrangement for the subsequent part.

In an assembly system, dimensional errors of printed parts can be measured prior to assembly and a unique target position is computed for the parts in a target arrangement (also referred to as a “virtual assembly”) prior to the physical assembly processes. in various embodiments, at this stage, the target arrangement can represent the target positions for each part based on their “as-printed” state, which ensures that the interfacing surfaces (e.g., tongues and grooves) can successfully be joined within the limits of the join geometry. The target arrangement is provided as input to the assembly system for generation of instructions to guide robots to assemble the parts in correct, target positions. The in-process error reduction begins after the first two parts have been assembled, as the assembly system tracks the physically assembled state of the assembly and its constituent parts using in-process measurements. After an assembly error is measured, the assembly system computes a correction that minimizes or reduces the dimensional error between the physical assembly state and the target (or virtual) assembly, and then may check if the correction still ensures that the interfacing surfaces of the subsequent joint to be connected can successfully be joined within the limits of the joint geometry (e.g., checks if a tongue of the subsequent part will still fit within a groove of the assembly). In some embodiments, the join geometry between two parts to be joined may include tongue-and-groove structures that have a “bond gap” between them in which adhesive is filled. In other words, when the tongue is inserted in the groove, the tongue may not touch the groove and there may be space around the tongue. This “bond gap” may be, for example, a millimeter on either side of the tongue and a millimeter from the edge of the tongue to the bottom of the groove. In various embodiments, the bond gap may be other dimensions that may give the assembly of the parts more or less leeway in joining, while the bond gap may still be small enough to allow adequate joint strength. Upon curing, a structural connection is realized between the two parts. Joint geometries including bond gaps are able to absorb assembly tolerances when connected. That is, the two parts can be joined in slightly different relative positions/orientations compared to target positions/orientations, thereby providing the ability to select from among a range of positions/orientations during the assembly process if needed, for example, to reduce the overall dimensional error when adding additional parts to an assembly that was not assembled exactly according to the target arrangement. If the ideal correction is too large (i.e., causes interference between the tongue and groove of the next joint to be connected), then the correction method can reduce the magnitude of the correction until a successful join can be ensured. Finally, the instructions for the robots that guide their positioning of the parts can be updated with the correction. This process is repeated after each new part is assembled to the assembly.

In this disclosure, the assembly error may be dynamically (e.g., “live”) measured and subsequent joins may be adjusted to correct for (i.e., reduce) the overall dimensional error during the assembly process. After each join for the assembly, the error of the join process is dynamically measured while the parts are still held by the robots. The assembly system then computes a correction that minimizes or reduces the error between the physical positions of the parts (and/or KPCs) and their original target positions that came out of the join process. This correction may be applied to a digital representation of the previously assembled part surfaces, and the joint surface of the subsequent join may be checked for interference with the mating joint and the correction may be reduced as needed.

A dynamic (e.g., live) interference check and reduction of the correction based on the available gaps between the joint surfaces may be performed prior to joining two parts. Such an order of operations may facilitate working with for arbitrary joint geometries and available gaps between the joint surfaces based on their as-printed locations. Once computed, a final connection applied. This may enable higher assembly accuracies to be achieved, which may enable less “extra” printed mass to be required, which saves on metal powder, and conserves overhead in terms of printing time and machining any extraneous printed mass.

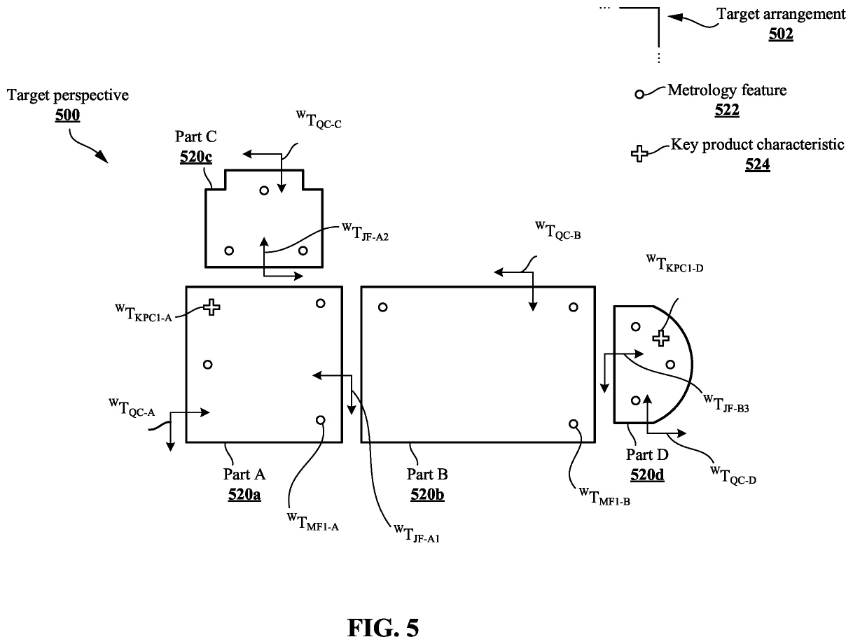

FIGS. 5 through 13 illustrate perspectives of joining parts using in-process error correction (reduction). In FIGS. 5-13, the target arrangement is drawn with solid lines, and the as-assembled (physical) arrangement is drawn with dashed lines. In FIGS. 5-13, cartesian coordinates frames are represented as four-by-four homogenous transformation matrices: ^{<reference frame>}T_{<type>-<part ID><join ID>}. Type may be quick q connect (QC), KPC, join frame (JF), part scan (STL), or metrology feature (MF). A QC feature can be a feature that the robot engages to hold the part, and the QC frame can be the frame of reference at the QC feature. The join frame can be the frame of reference along which the part will be joined with another part. Reference frame can be expressed in assembly (e.g., vehicle) coordinates (W) or another frame of the aforementioned types, such as QC frame, JF, etc.

FIG. 5 illustrates a perspective 500 of a target arrangement 502 of an assembly. As shown in the legend, target arrangement 502 is drawn with solid lines. Target arrangement 502 includes the target arrangements of four parts: Part A 520a, Part B 520b, Part C 520c, and Part D 520d (each part drawn with the solid lines shown in the legend). Each of the parts 520a-520d may include a set of metrology features 522, which are shown as small circles on the parts in the figures. The metrology features may be used to locate positions of parts, such as shown in FIG. 4 in which the measurement/vision system(s) 406 captures data that is provided to the computing system 404. In addition, an assembly may include one or more KPCs 524, shown as “plus signs” in the figures, which may need to be positioned more accurately than other areas of the assembly. For example, a KPC may be an area that needs to meet a clearance requirement, an area that will be machined after assembly, or another characteristic that it is beneficial to account for when fitting a physical arrangement to a target arrangement.

Illustratively, for a QC frame of Part A 520a with respect to vehicle coordinates, the virtual assembly position can be expressed as ^{W}T_{QC-A} 506a, the position after join n error is measured can be expressed as ^{W}T_{QC-An}, and the position after the join n best-fit error correction is applied can be expressed as ^{W}T_{QC-An′}. Similarly, for a KPC frame of Part D 520d with respect to vehicle coordinates, the virtual assembly position can be expressed as ^{W}T_{KPC1-D}, the position after join n error is measured can be expressed as ^{W}T_{KPC1-Bn}, and the position after the join n best-fit error correction is applied can be expressed as ^{W}T_{KPC1-Bn′}.

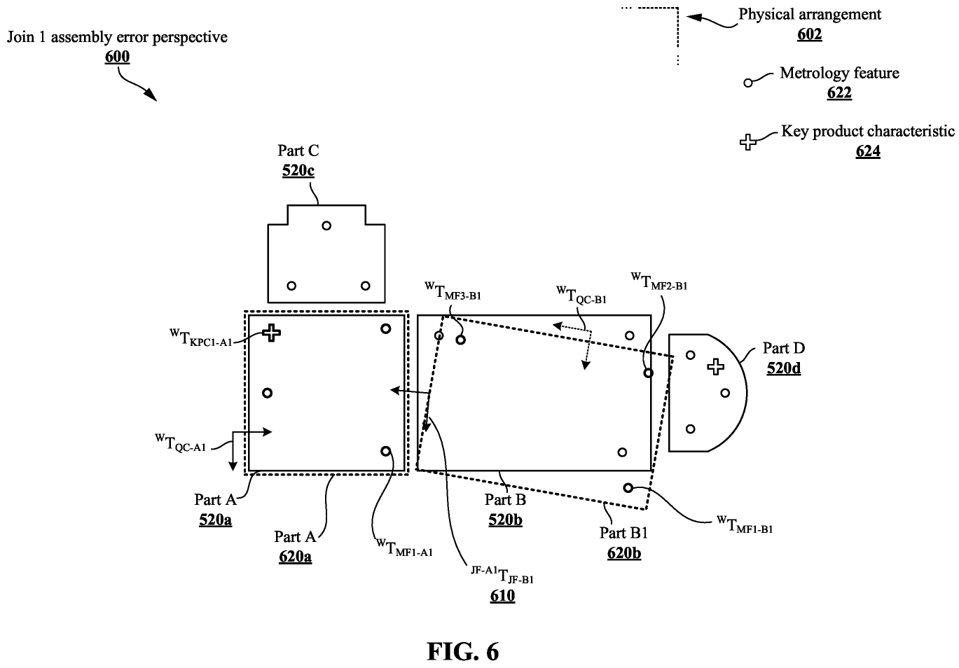

FIG. 6 illustrates a perspective 600 of a physical arrangement 602 of the physical Part A 620a and Part B 620b shown as assembled and superimposed on the target arrangement, parts 520a-520d. The physical parts 620a-b are each drawn with dashed lines as shown in the legend to more easily distinguish from the target arrangement drawn with solid lines). As FIG. 6 illustrates, the physical arrangement of Part A 620a is superimposed exactly matching the target arrangement Part A 520a, but the physical arrangement of Part B 620b does not match the target arrangement Part B 520a. In other words, there is an assembly error, which is represented as an assembly error 610, after a first join of Part B 620b with Part A 620a. The assembly error can be understood as a deviation of the physical arrangement 602 from the target arrangement 502. In particular, the assembly error 610 of join 1, reflected by the transformation matrix ^{JF-A1}T_{JF-B1}, may result in the location of Part B1 620b in the physical arrangement 602 deviating from the location of Part B 520b in the target arrangement 502. This deviation may commensurately results in the positions of the metrology features 622 of Part B1 620b in the physical arrangement 602 deviating from the positions of the metrology features 522 of Part B 520b in the target arrangement 502.

The assembly error 610 of the Part B join frame may be measured with respect to Part A in the assembly process, e.g., after join retention but before robot release. Part A may be fixed from a previous state when an assembly error transformation is applied—e.g., ^{W}T_{KPC1-A}=^{W}T_{KPC1-A1}; ^{W}T_{QC-A}=^{W}T_{QC-A1}; ^{W}T_{MF1-A}=^{W}T_{MF1-A1}. The measured assembly error may be applied to features of Part B in the join sequence.

To apply the measured assembly error, the position of Part B1 620b and its associated features in the physical arrangement 602 may be computed from the position of Part B 520b and its associated features in the target arrangement 502. For Part B 520b in the target arrangement 502, the join error ^{JF-A1}T_{JF-B1} may be measured and the following may be given: ^{W}T_{JF-A}; ^{W}T_{JF-B}; ^{W}T_{QC-B}; ^{W}T_{MF1-B}; ^{W}T_{MF2-B}; ^{W}T_{MF3-B}. Therefrom, the following may be computed for the positions of Part B1 620b and its associated features: ^{W}T_{QC-B1}; ^{W}T_{MF1-B1}; ^{W}T_{MF2-B1}; ^{W}T_{MF3-B1}.

The Part B1 QC frame with respect to the Part B1 join 1 frame can be computed as:

^{JF-B1}T_{QC-B1}=(^{W}T_{JF-B})⁻¹*^{W}T_{QC-B}

The Part B1 QC frame in assembly (e.g., vehicle) coordinates after applying the assembly error transformation can be computed as:

^{W}T_{QC-B1}=^{W}T_{JF-A1}*^{JF-A1}T_{JF-B1}*^{JF-B1}T_{QC-B1}

Similarly, the QC frame of the first of the metrology features 622 of Part B1 620b can be computed with respect to the Part B1 join frame as:

^{JF-B1}T_{MF1-B1}=(^{W}T_{JF-B})⁻¹*^{W}T_{MF1-B}

The QC frame of the first metrology feature of Part B1 620b can be computed in assembly (e.g., vehicle) coordinates after applying the assembly error transformation as:

^{W}T_{MF1-B1}=^{W}T_{JF-A1}*^{JF-A1}T_{JF-B1}*^{JF-B1}T_{MF1-B1}

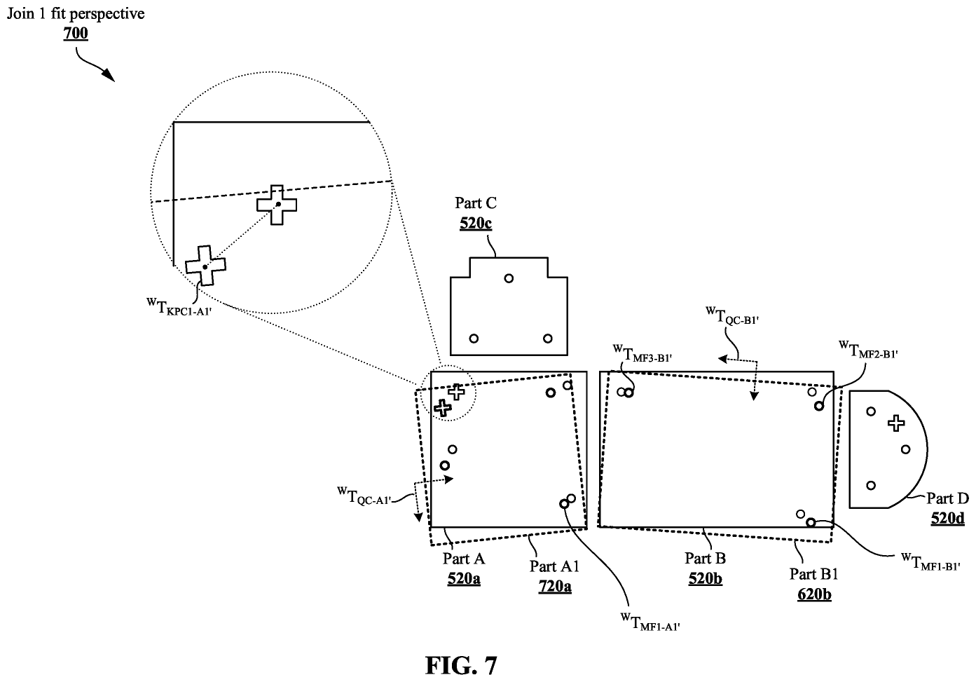

FIG. 7 illustrates a perspective 700 of fitting the physical arrangement of parts to the target arrangement of parts after the first join. The physical arrangement 602 of Part A1 720a and Part B1 620b after the first join may be fitted to the target arrangement 502 of Part A 520 and Part B 520. The fitting may be performed mathematically, as represented in FIG. 7. In various embodiments, the physical assembly may be moved to the fitted position. The following may be given from the target arrangement 502 or computed as shown with respect to FIG. 6, supra: ^{W}T_{QC-A1}; ^{W}T_{QC-B1}; ^{W}T_{KPC1-A1}; ^{W}T_{MF1-B1}; ^{W}T_{MF2-B1}; ^{W}T_{MF3-B1}; and ^{W}T_{U1} (where U1 is a position after join 1); ^{W}T_{QC-A1′}; ^{W}T_{QC-B1′}; ^{W}T_{KPC1-A1′}; ^{W}T_{MF1-B1′}; ^{W}T_{MF2-B1′}; ^{W}T_{MF3-B1′}.

Respective differences in positions between each of the corresponding pairs of same features (e.g., metrology features 522 of the target arrangement 502 may correspond to metrology features 622 of the physical arrangement 602) may be determined. Various embodiments may use only the positions of the metrology features as positions for the fitting because the physical positions of the metrology features may be more accurately measured. In embodiments in which KPCs are not used as positions in the fitting, the fitting may still take into account the KPCs and may weight the fitting accordingly so that the fitted positions of the KPCs are reduced or minimized using, e.g., the positions of the metrology features as a guide.

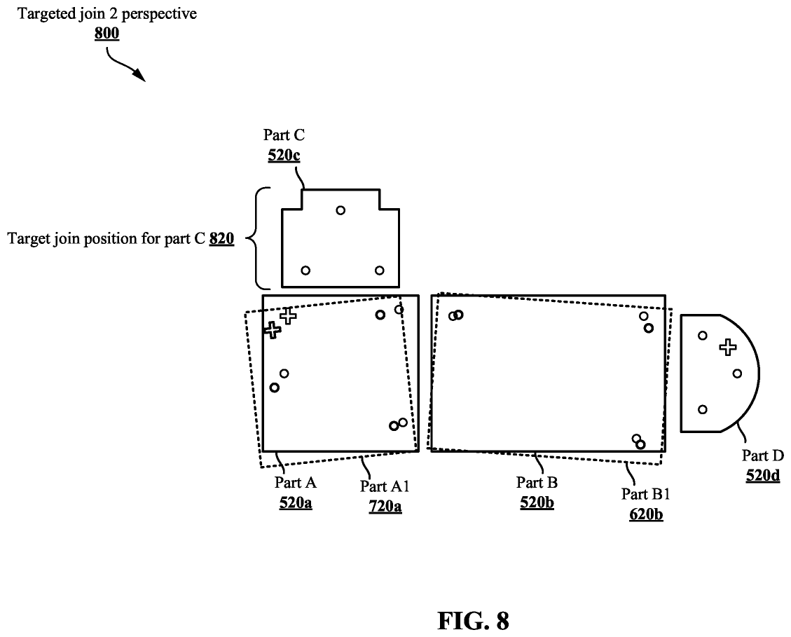

FIG. 8 illustrates a perspective 800 showing the position of a third part in the target arrangement after fitting the physical arrangement of Parts A and B to the target arrangement. Although the position of the third part, i.e., Part C 520c, has not changed in the target arrangement, FIG. 8 shows that because the physical arrangement has been corrected, e.g., fit, according to method herein, the target position of Part C has been “adjusted” relative to the physical arrangement. Put another way, the physical arrangement has been adjusted (fit, corrected) relative to the target arrangement, so that when Part C is moved into its target position in the target arrangement, the physical arrangement will be at a location that provides the appropriate correction to the overall assembly. In this way, for example, the overall dimensional error of the assembly may be reduced or minimized.

To fit the physical arrangement 602 of Part A1 720a and Part B1 620b after the first join to the target arrangement 502 of Part A 520a and Part B 520b, a best-fit transformation of Part A1 720a and Part B1 620b in their physical arrangement positions to the Part A 520a and Part B 520b positions in the target arrangement 502 may be computed as:

$$minimize {\sum }_{i = 1}^{m} {‖ {p}_{i}^{′} - ( {}^{W} {T}_{U 1} ⋆ {p}_{i} ) ‖}^{2}$$

Due to the retention process, the positions of Part A1 720a and Part B1 620b in their physical arrangement positions remain fixed with respect to one another. Therefore, ^{W}T_{QC-A1′}=^{U1}T_{QC-A1}; ^{W}T_{QC-B1}=^{U1}T_{QC-B1′}; ^{W}T_{MF1-B1}=^{W}T_{MF1-B1′}; ^{W}T_{KPC1-A1}=^{W}T_{KPC1-A1′}, etc.

The best-fit correction for join 1 can thus be applied to Part A and Part B and their respective features: ^{W}T_{QC-A1′}=^{W}T_{U1}*T_{QC-A1′}; ^{W}T_{QC-B1′}=^{W}T_{U1}*^{U1}T_{QC-B1′}; ^{W}T_{MF1-B1′}=^{W}T_{U1}*^{U1}T_{QC-B1′}; ^{W}T_{KPC1-A1′}=^{W}T_{U1}*^{U1}T_{KPC1-A1′}, etc.

Using the best-fit correction, the join 2 position of Part C 520c can place Part C in its target position 520c in the target arrangement 502, and the physical arrangement of Parts A and B may be in an adjusted position to fit the physical arrangement of Part A1 720a and Part B1 620b after join 1. Illustratively, Part C may be brought to a target join position 820 at which Part C may be physically joined with Part A of the assembly. Although the method described herein refers to adjusting (fitting, correcting) the physical arrangement, it should be understood that the adjusting is relative and could be done to the target arrangement instead, or could be done to both the physical arrangement and the target arrangement.

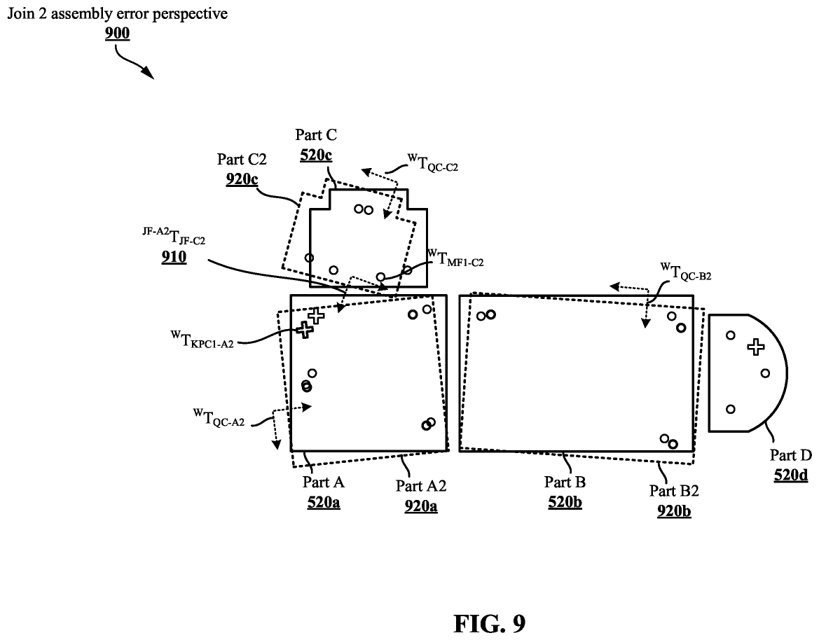

FIG. 9 illustrates a perspective 900 of a physical arrangement of parts with an assembly error 910 after a second join, i.e., a join of Part C with Part A of the physical arrangement of Parts A and B. The target position of Part C is shown as Part C 520c, but as FIG. 9 illustrates, the actual assembly position of Part C does not match 520c due to error in the assembly process, such as robot error. The assembly error 910, reflected by the transformation matrix ^{JF-A2}T_{JF-C2}, can be expressed as a deviation of the physical arrangement from the target arrangement 502. In particular, the assembly error 910 of join 2 may result in the location of Part C2 920c in the physical arrangement 602 deviating from the location of Part C 520c in the target arrangement 502. This deviation may commensurately result in the positions of the metrology features 622 of Part C2 920c in the physical arrangement 602 deviating from the positions of the metrology features 522 of Part C 520c in the target arrangement 502.

The assembly error 910 of the Part C join frame may be measured with respect to Part A in the assembly process, e.g., after join retention but before robot release. Part A may be fixed from the previous state when an assembly error transformation is applied—e.g., ^{W}T_{KPC1-A1′}=^{W}T_{KPC1-A2}; ^{W}T_{QC-A1′}=^{W}T_{QC-A2}; ^{W}T_{MF1-A1′}=^{W}T_{MF1-A2}. The measured assembly error may be applied to Part C in the join sequence, as shown by Part C2 920c in the physical arrangement.

To apply the measured assembly error, the position of Part C2 920c and its associated features in the physical arrangement may be computed from the target join position 820 of Part C and its associated features in the target arrangement. For Part C in the target join position 820, the error of the Part C join frame ^{JF-A2}T_{JF-C2} may be measured and the following may be given: ^{W}T_{JF-A2}; ^{W}T_{JF-B2}; ^{W}T_{QC-B2}; ^{W}T_{MF1-B2}; ^{W}T_{MF2-B2}; ^{W}T_{MF3-B2}. Therefrom, the following may be computed for the positions of Part C2 920c and its associated features: ^{W}T_{QC-C2}; ^{W}T_{MF1-C2}; ^{W}T_{MF2-C2}; ^{W}T_{MF3-C2}.

The Part C2 QC frame with respect to the Part A2 join 2 frame can be computed as:

^{JF-A2}T_{QC-C2}=(^{W}T_{FJ-C2})⁻¹*^{W}T_{QC-C2}

The Part C2 QC frame in assembly (e.g., vehicle) coordinates after applying the assembly error transformation can be computed as:

^{W}T_{QC-C2}=^{W}T_{JF-A2}*^{JF-A2}T_{JF-C2}*^{JF-C2}T_{QC-C2}

Similarly, the QC frame of the first of the metrology features of Part C2 920c can be computed with respect to the Part C2 join frame as:

^{JF-C2}T_{MF1-C2}=(^{W}T_{JF-C2})⁻¹*^{W}T_{MF1-C2}

The QC frame of the first metrology feature of Part C2 920c can be computed in assembly (e.g., vehicle) coordinates after applying the assembly error transformation as:

^{W}T_{MF1-C2}=^{W}T_{JF-A2}*^{JF-A2}T_{JF-C2}*^{JF-C2}T_{MF1-C2}

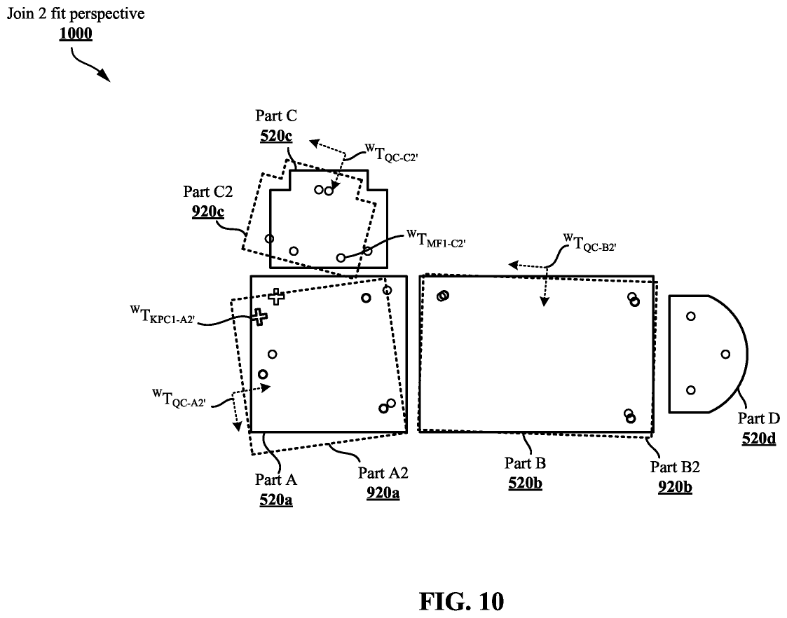

FIG. 10 illustrates a perspective 1000 of fitting the physical arrangement of parts to the target arrangement of parts after the second join. The physical arrangement of Part A2 920a, Part B2 920b, and Part C2 920c after the second join may be fitted to the target arrangement 502 of Part A 520, Part B 520, and Part C (e.g., at target join position 820). The following may be given from the target arrangement or computed as shown with respect to FIG. 9, supra: ^{W}T_{QC-A2}; ^{W}T_{QC-C2}; ^{W}T_{KPC1-A2}; ^{W}T_{MF1-A2} . . . ; ^{W}T_{KPC1-C2}; ^{W}T_{MF1-C2} . . . ; and ^{W}T_{U2} (where U2 is a position after join 2); ^{W}T_{QC-A2′}; ^{W}T_{QC-C2′}; ^{W}T_{KPC1-A2′}; ^{W}T_{MF1-A2′}. . . ; ^{W}T_{MF1-C2}; ^{W}T_{MF2-C2′}. . . .

Respective differences in positions between each of the corresponding pairs of same features (e.g., metrology features of the target arrangement may correspond to metrology features of the physical arrangement) may be determined.

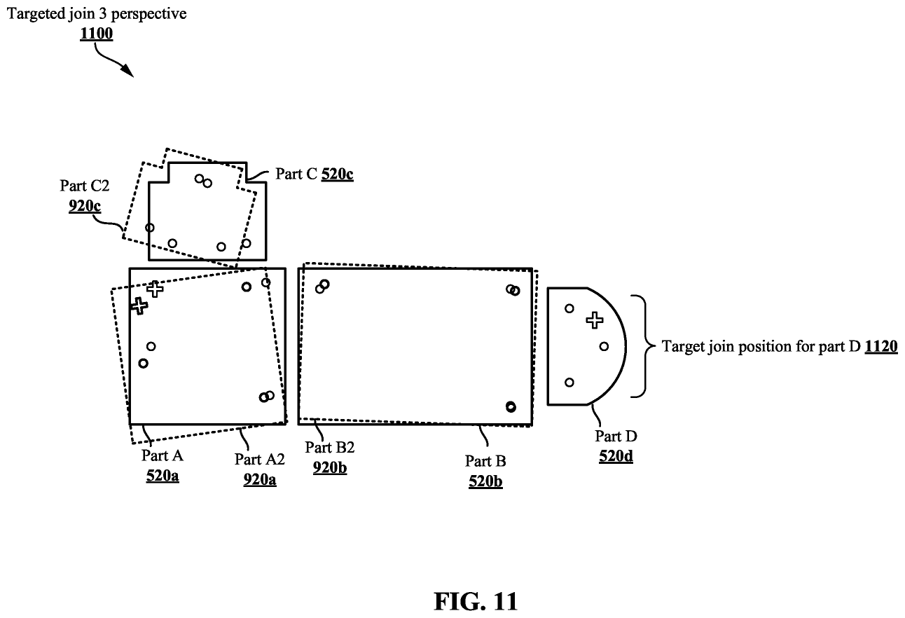

FIG. 11 illustrates a perspective 1100 showing the position of a fourth part in the target arrangement after fitting the physical arrangement of Parts A, B, and C to the target arrangement. Similar to described above, although the position of the fourth part, i.e., Part D 520d, has not changed in the target arrangement, FIG. 11 shows that because the physical arrangement has been corrected, e.g., fit, according to method herein, the target position of Part D has been “adjusted” relative to the physical arrangement. Put another way, the physical arrangement has been adjusted (fit, corrected) relative to the target arrangement, so that when Part D is moved into its target position in the target arrangement, the physical arrangement will be at a location that provides the appropriate correction to the overall assembly. In this way, for example, the overall dimensional error of the assembly may be reduced or minimized. To fit the physical arrangement of Part A2 920a, Part B2 920b, and Part C2 920c after the second join to the target arrangement, a best-fit transformation of scans (e.g., 3-D scans) of Part A2 920a, Part B2 920b, and Part C2 920c in their physical arrangement positions to their respective Part A, Part B, and Part C positions in the target arrangement 502 may be computed as:

$$minimize {\sum }_{i = 1}^{m} {‖ {p}_{i}^{′} - ( {}^{W} {T}_{U 2} ⋆ {p}_{i} ) ‖}^{2}$$

Due to the retention process, the positions of Part A2 920a and Part C2 920c in their physical arrangement positions remain fixed with respect to one another. Therefore, ^{W}T_{QC-A2}=^{U2}T_{QC-A2′}; ^{W}T_{QC-C2}=^{U2}T_{QC-C2′}; ^{W}T_{MF1-A2}=^{U2}T_{MF-A2′}; ^{W}T_{KPC1-A2}=^{U2}T_{KPC1-A2′}, etc.

The best-fit correction for join 2 can thus be applied to Part A and Part C and their respective features: ^{W}T_{QC-A2′}=^{W}T_{U2}*^{U2}T_{QC-A2′}; ^{W}T_{QC-C2′}=^{W}T_{U2}*^{U2}T_{QC-C2′}; ^{W}T_{MF1-C2′}=^{W}T_{U2}*T_{QC-C2′}; ^{W}T_{KPC1-A2′}=^{W}T_{U2}*^{U2}T_{KPC1-A2′}, etc.

Using the best-fit correction, the join 3 position of Part D 520d in the target arrangement 502 may be adjusted to fit the physical arrangement of Part B2 920b after join 2. Illustratively, Part D may be brought to a target join position 1120 at which Part D may be physically joined with Part B of the assembly.

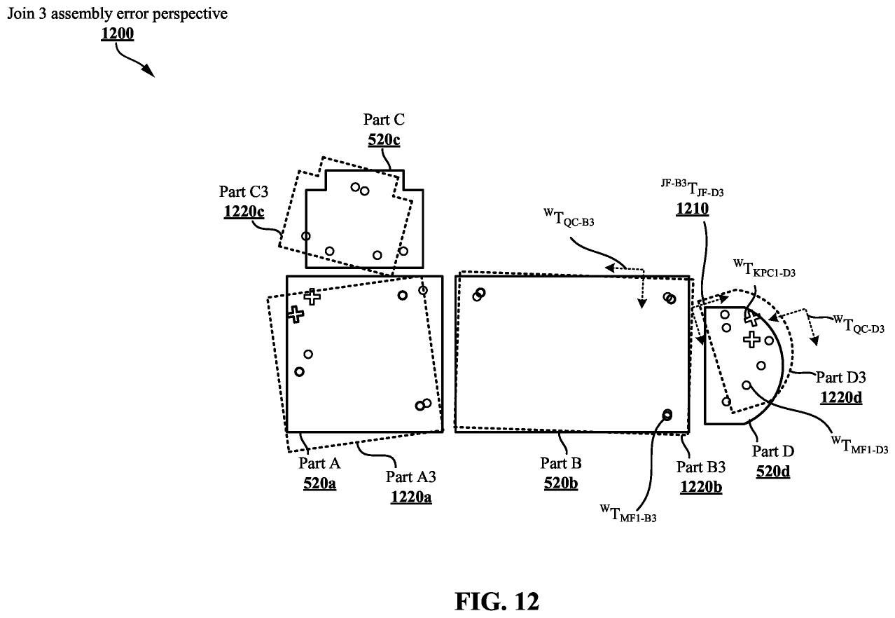

FIG. 12 illustrates a perspective 1200 of a physical arrangement of parts with an assembly error 1210 after a third join, i.e., a join of Part D with Part B of the physical arrangement of Parts A, B, and C. The target position of Part D is shown as Part D 520d, but as FIG. 12 illustrates, the actual assembly position of Part D does not match 520d due to error in the assembly process, such as robot error. The assembly error 1210, reflected by the transformation matrix ^{JF-B3}T_{JF-D3}, can be expressed as a deviation of the physical arrangement from the target arrangement 502. In particular, the assembly error 1210 of join 3 may result in the location of Part D3 1220d in the physical arrangement deviating from the location of Part D 520d in the target arrangement 502. This deviation may commensurately results in the positions of the metrology features 622 of Part D3 1220d in the physical arrangement deviating from the positions of the metrology features 522 of Part D 520d in the target arrangement 502.

The assembly error 1210 of the Part D join frame may be measured with respect to Part B in the assembly process, e.g., after join retention but before robot release. Part B may be fixed from the previous state when an assembly error transformation is applied—e.g., ^{W}T_{QC-B2′}=^{W}T_{QC-B32}; ^{W}T_{MF1-B2′}=^{W}T_{MF1-B3}; ^{W}T_{MF2-B2′}=^{W}T_{MF2-B3}. The measured assembly error may be applied to Part D in the join sequence, as shown by Part D3 1220d in the physical arrangement.

To apply the measured assembly error, the position of Part D3 1220d and its associated features in the physical arrangement may be computed from the target join position 1120 of Part D and its associated features in the target arrangement. For Part D in the target join position 1120, the error of the Part D join frame ^{JF-B3}T_{JF-D3} may be measured and the following may be given: ^{W}T_{JF-A3}; ^{W}T_{JF-B3}; ^{W}T_{QC-B3}; ^{W}T_{MF1-B3}; ^{W}T_{MF2-B3}; ^{W}T_{MF3-B3}. Therefrom, the following may be computed for the positions of Part D3 1220d and its associated features: ^{W}T_{QC-D3}; ^{W}T_{KPC1-D3}; ^{W}T_{MF1-D3}; ^{W}T_{MF2-D3}; ^{W}T_{MF3-D3}.

The Part D3 QC frame with respect to the Part B3 join 3 frame can be computed as:

^{JF-B3}T_{QC-D3}=(^{W}T_{JF-D3})⁻¹*^{W}T_{QC-D3}

The Part D3 QC frame in assembly (e.g., vehicle) coordinates after applying the assembly error transformation can be computed as:

^{W}T_{QC-D3}=^{W}T_{JF-B3}*^{JF-B3}T_{JF-D3}*^{JF-D3}T_{QC-D3}

Similarly, the QC frame of the first of the KPC features 624 of Part D3 1220d can be computed with respect to the Part D3 join frame as:

^{JF-D3}T_{KPC1-D3}=(^{W}T_{JF-D3})⁻¹*^{W}T_{KPC1-D3}

The QC frame of the first of the metrology features of Part D3 1220d can be computed with respect to the Part D3 join frame as:

^{JF-D3}T_{MF1-D3}=(^{W}T_{JF-D3})⁻¹*^{W}T_{MF1-D3}

The QC frame of the first KPC feature of Part D3 1220d can be computed in assembly (e.g., vehicle) coordinates after applying the assembly error transformation as:

^{W}T_{KPC1-D3}=^{W}T_{JF-B3}*^{JF-B3}T_{JF-D3}*^{JF-D3}T_{KPC1-D3}

The QC frame of the first metrology feature of Part D3 1220d can be computed in assembly (e.g., vehicle) coordinates after applying the assembly error transformation as:

^{W}T_{MF1-D3}=^{W}T_{JF-B3}*^{JF-B3}T_{JF-D3}*^{JF-D3}T_{MF1-D3}

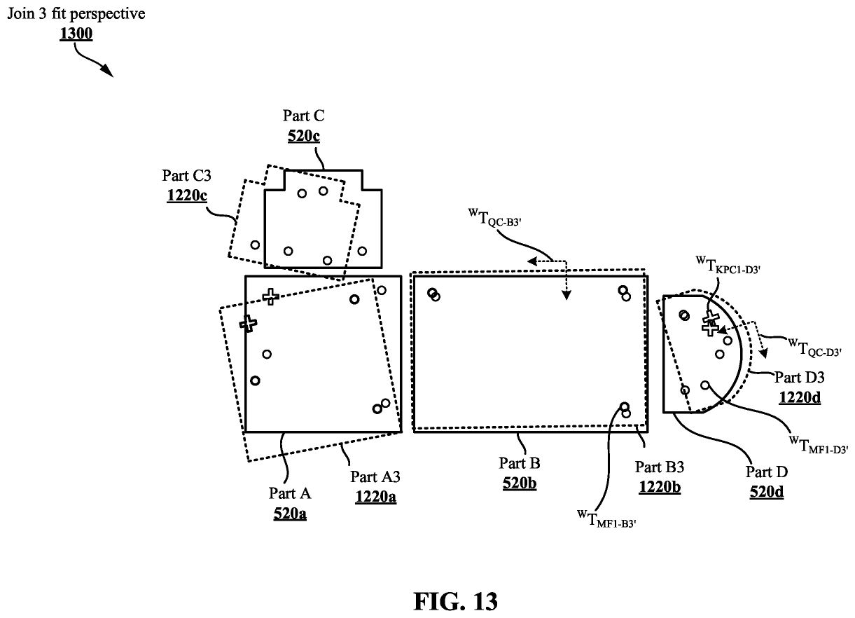

FIG. 13 illustrates a perspective 1300 of fitting the physical arrangement of parts to the target arrangement of parts after the third join. The physical arrangement of Part A3 1220a, Part B3 1220b, Part C3 1220c, and Part D3 1220d after the third join may be fitted to the target arrangement 502 of Part A 520, Part B 520, Part C, and Part D (e.g., at target join position 1120). The following may be given from the target arrangement or computed as shown with respect to FIG. 12, supra: ^{W}T_{QC-B3}; ^{W}T_{QC-D3}; ^{W}T_{MF1-B3} . . . ; ^{W}T_{KPC1-D3}; ^{W}T_{MF1-D3} . . . ; and ^{W}T_{U3} (where U3 is a position after join 3); ^{W}T_{QC-B3′}; ^{W}T_{QC-D3′}; ^{W}T_{MF1-B3′} . . . ; ^{W}T_{KP1-D3′}; ^{W}T_{MF1-D3′} . . . .

Respective differences in positions between each of the corresponding pairs of same features (e.g., metrology features of the target arrangement may correspond to metrology features of the physical arrangement) may be determined.

To fit the physical arrangement of Part A3 1220a, Part B3 1220b, Part C3 1220c, and Part D3 1220d after the third join to the target arrangement, a best-fit transformation of scans (e.g., 3-D scans) of Part A3 1220a, Part B3 1220b, Part C3 1220c, and Part D3 1220d in their physical arrangement positions to their respective Part A, Part B, Part C, and Part D positions in the target arrangement 502 may be computed as:

$$minimize {\sum }_{i = 1}^{m} {‖ {p}_{i}^{′} - ( {}^{W} {T}_{U 3} ⋆ {p}_{i} ) ‖}^{2}$$

Due to the retention process, the positions of Part B3 1220b and Part D3 1220d in their physical arrangement positions remain fixed with respect to one another. Therefore, ^{W}T_{QC-B3}=^{U3}T_{QC-B3′}; ^{W}T_{QC-D3}=^{U3}T_{QC-D3′}; etc.

The best-fit correction for join 2 can thus be applied to Part B and Part D and their respective features: ^{W}T_{QC-B3′}=^{W}T_{U3}*^{U3}T_{QC-B3′}; ^{W}T_{QC-D3′}=^{W}T_{U3}*^{U3}T_{QC-D3′}; ^{W}T_{MF1-D3′}=^{W}T_{U3}*^{U3}T_{QC-D3′}; ^{W}T_{KPC1-D3′}=^{W}T_{U3}*^{U3}T_{KPC1-D3′}, etc.

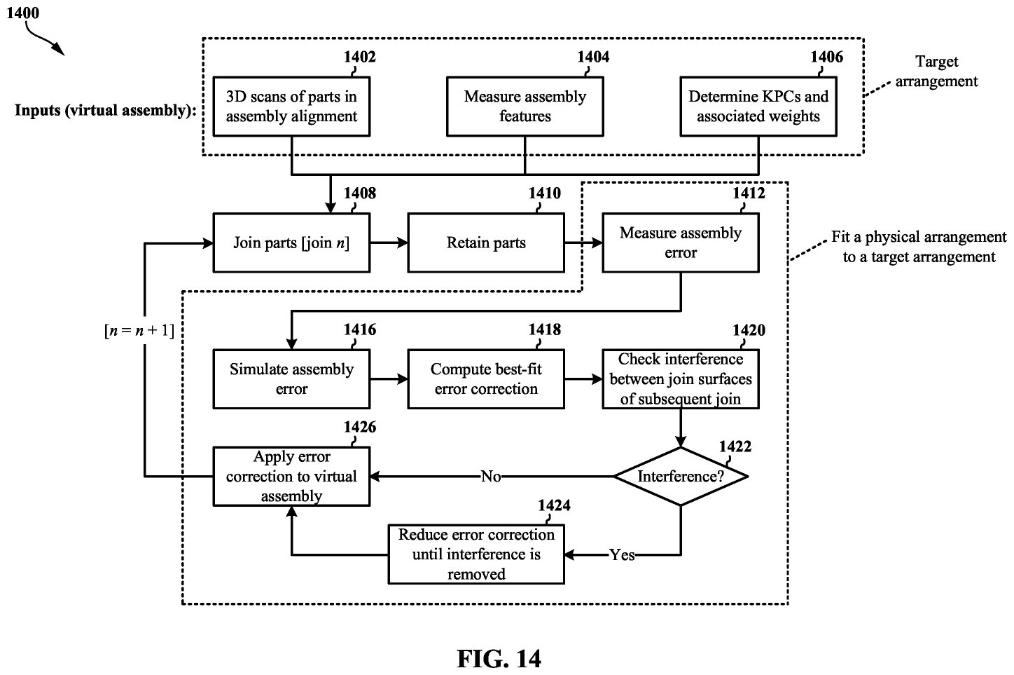

FIG. 14 is a flowchart illustrating an example of a method 1400 of in-process assembly error correction, in accordance with various aspects of the present disclosure. The method 1400 may be performed by an assembly system, such as assembly system 400, which may include at least one computing system 404 and one or more robots 410, 412, 414, 416. According to various different embodiments, one or more of the illustrated operations may be omitted, transposed with another operation, or contemporaneously performed with another operation.

The assembly system may be provided a virtual assembly, i.e., target arrangement, which may indicate a desired completed assembly. For example, the assembly system may scan all parts to be assembled in an assembly (1402). The assembly system may measure assembly features of the parts (1404), e.g., based on the 3-D scans of each of the parts. The assembly system may determine a set of KPCs and associated weights (1406). From the information scanned and features determined, the assembly system may generate the target arrangement of parts that are to be joined to form an assembly.

The assembly system may robotically join parts for a join n (e.g., n=1 for the first iteration) (1408). The assembly system may retain the joined parts (1410), e.g., so that the joined parts remain fixed with respect to one another.

To fit a physical arrangement to a target arrangement, the assembly system may measure an assembly error (1412), which may result from the physical joining n of parts. The assembly system may simulate the assembly error (1416), for example, using methods described herein. From the simulated assembly error and the target arrangement, the assembly system may compute a best-fit error correction (1418). The assembly system may check interference(s) between join surfaces of a subsequent join (1420). For example, the system may check if the joining of the next part, based on the fitted physical assembly and the target position of the next part in the target assembly, would cause the parts to interfere with each other. For example, a tongue of the next part might not fit into a corresponding groove of the fitted physical assembly. In this case, the system may adjust the fitting of the physical assembly to allow the tongue to fit into the groove. The adjustment can be a minimum adjustment, for example, to keep the fitted physical assembly as close to its fitted position as possible.

The assembly system may decide (1422) whether any interference(s) would occur. If interference occurs from applying the best-fit error correction, then the assembly system may reduce the error correction (e.g., reduce the magnitude or degree of the error correction) until the interference is removed (1424).

Once the interference is removed, or if no interference is determined to occur, then the assembly system may apply the error correction to the virtual assembly (e.g., fitted arrangement) (1426). The assembly system may then proceed to the next join n+1.

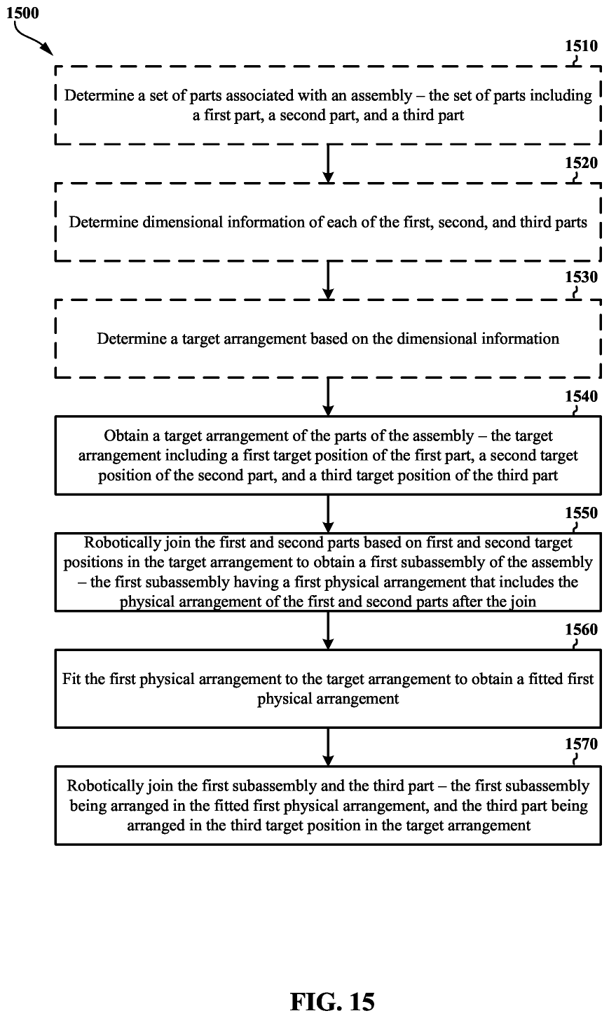

FIG. 15 is a flowchart illustrating another example of a method 1500 of in-process assembly error correction, in accordance with various aspects of the present disclosure. The method 1500 may be performed by an assembly system, such as assembly system 400, which may include at least one computing system 404 and one or more robots 410, 412, 414, 416. According to various different embodiments, one or more of the illustrated operations may be omitted, transposed with another operation, or contemporaneously performed with another operation.

The assembly system (e.g., a computing system) may be configured to determine a set of parts associated with an assembly (1510). The set of parts may include a first part, a second part, and a third part. The assembly system (e.g., the computing system) may be further configured to determine dimensional information, e.g., by scanning, of each of the first, second, and third parts (1520). The assembly system (e.g., the computing system) may be configured to determine a target arrangement based on the dimensional information (1530). The parts 1510, 1520, and 1530 may be optional, which is indicated visually in the figure by the dashed-lined boxes. That is, in various embodiments, a target arrangement need not be determined based on actual, e.g., scanned, dimensions of the parts. In various embodiments, for example, a target arrangement may be determined with CAD data, i.e., “ideal” dimensions, of the parts.

The assembly system (e.g., the computing system) may be further configured to obtain a target arrangement of the parts of the assembly (1540). The target arrangement may include a first target position of a first part, a second target position of a second part, and a third target position of a third part.

The assembly system (e.g., one or more of the robots) may be further configured to robotically join the first part and the second part based on the first target position and the second target position in the target arrangement to obtain a first subassembly of the assembly (1550). The first subassembly may have a first physical arrangement, and the first physical arrangement may include the physical arrangement of the first and second parts after being robotically joined.

The assembly system (e.g., the computing system) may be further configured to fit the first physical arrangement to the target arrangement to obtain a fitted first physical arrangement (1560). The assembly system (e.g., one or more of the robots) may be further configured to robotically join the first subassembly and the third part (1570), such that the first subassembly may be arranged in the fitted first physical arrangement, and the third part may be arranged in the third target position in the target arrangement.

In some embodiments, the target arrangement further may include a fourth target position of a fourth part, and robotically joining the first subassembly and the third part obtains a second subassembly of the assembly, the second subassembly may have a second physical arrangement, and the second physical arrangement may include the physical arrangement of the first, second, and third parts after joining. The assembly system may be further configured to fit the second physical arrangement to the target arrangement to obtain a fitted second physical arrangement. The assembly system (e.g., the one or more robots) may be further configured to robotically join the second subassembly and the fourth part, and the second subassembly may be arranged in the fitted second physical arrangement, and the fourth part may be arranged in the fourth target position in the target arrangement.

In some embodiments, the assembly system (e.g., the computing system) may fit the first physical arrangement to the target arrangement by performing a best-fit correction. For example, the best-fit correction may include determining a difference in position between each of a plurality of corresponding pairs of same features of the first physical arrangement and the target arrangement, and minimizing an error based on the differences in position. In some embodiments, minimizing the error may include minimizing a sum of the squares of the differences of position.

In some embodiments, the assembly system (e.g., the computing system) may fit the first physical arrangement to the target arrangement by determining a difference between a first join position of the first part and a first target join position of the first part, and determining a second target join position at which to join the third part with the first part based on the difference.

In some embodiments, the assembly system (e.g., the computing system) may be further configured to determine, prior to joining the first subassembly and the third part, an interference between the first subassembly and the third part; and adjust the fitted first physical arrangement if the interference exceeds a threshold. In some embodiments, interference may include a portion of the first subassembly contacting a portion of the third part. In some embodiments, the interference may be determined further based on a tolerance of a joint between the third part and the first part.

In some embodiments, the assembly system (e.g., a measurement system) measuring a first part position of the first part and a second part position of the second part based on a set of key product characteristics associated with the first part and the second part. In some embodiments, fitting the first physical arrangement to the target arrangement may be based on the first part position and the second part position.

In some embodiments, the key product characteristics may include at least one of a tolerance associated with a joint included in the assembly, a clearance associated with the assembly, or a surface profile associated with the assembly.

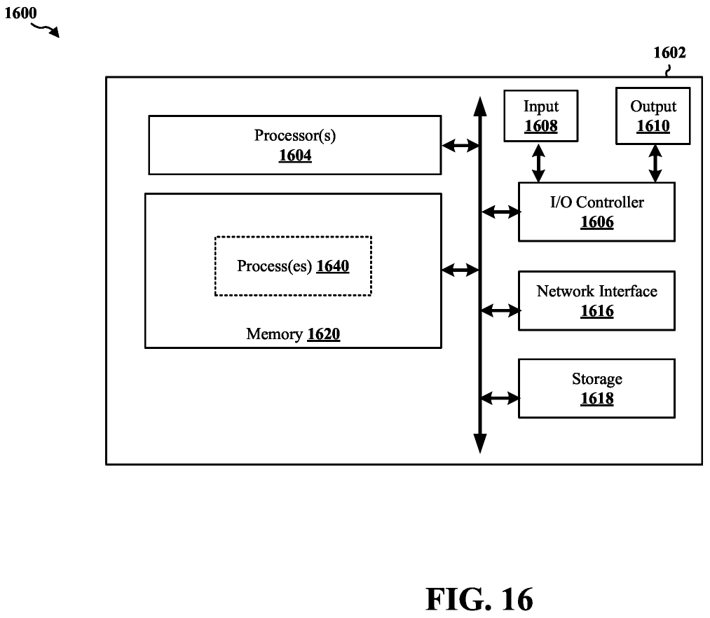

FIG. 16 is a diagram illustrating an example of a hardware implementation 1600 for an example apparatus 1602, in accordance with various aspects of the present disclosure. The apparatus 1602 may be a computing system or similar device(s), or the apparatus 1602 may be a component of a computing system or similar device(s). The apparatus 1602 may include a processor(s) 1604 and a memory 1620, which may be coupled together and/or integrated into the same package, component, circuit, chip, and/or other circuitry. The processor(s) 1604 may include, for example, a CPU, GPU, application processor, SoC, microprocessor, and/or other processor(s). The memory 1620 may include, for example, RAM, ROM, and/or other memory configured to store computer-executable instructions. The processor(s) 1604 and memory 1620 may be configured to perform various aspects described in connection with one or more components of assembly system 400 described in connection with FIG. 4.

The apparatus 1602 may further include an I/O controller 1606, a network interface 1616, and storage 1618. The I/O controller 1606 may be coupled to an input 1608, which may include one or more input devices, such as a keyboard, mouse, touchscreen, a microphone, and the like. The I/O controller 1606 may be further coupled to an output 1610, which may include one or more output devices, such as a display, a speaker, a haptic feedback device, and the like. The network interface 1616 may connect the apparatus 1602 with one or more other computing systems over at least one network, which may be wired or wireless. For example, the network interface 1616 may enable a connection to the Internet, a LAN, a WAN, a PAN, an enterprise network, and/or one or more other networks. The storage 1618 may include volatile and/or non-volatile storage or memory, such as RAM, ROM, EEPROM, optical disk storage, magnetic disk storage, other magnetic storage devices, combinations of the aforementioned types of computer-readable media, or any other medium that can be used to store computer-executable code in the form of instructions or data structures that can be accessed by a computer.

The processor(s) 1604, with the memory 1620, may be responsible for general processing, including the execution of instructions stored in the memory 1620 (e.g., a non-transitory computer-readable medium/memory). The instructions, when executed by the processor(s) 1604, may cause the processor(s) 1604 to perform various functions described supra. The memory 1620 may also be used for storing data that is manipulated by the processor(s) 1604 when executing instructions.

The processor(s) 1604 may execute instructions of process(es) 1640, which may be fetched into memory 1620 for execution by the processor(s) 1604. Process(es) 1640 may include any of the functions described herein, such as the operations described with respect to FIGS. 14 and 15, supra.

The apparatus 1602 may include additional components that perform some or all of the blocks, operations, signaling, etc. of the algorithms in the above-described FIGS. 14 and 15. As such, some or all of the blocks, operations, signaling, etc. in FIGS. 14 and 15 may be performed by one or more components and the apparatus 1602 may include one or more such components. The components may be one or more hardware components specifically configured to carry out the stated processes/algorithm, implemented by a processor configured to perform the stated processes/algorithm, stored within a computer-readable medium for implementation by a processor, or some combination thereof.

The specific order or hierarchy of blocks or operations in each of the foregoing processes, flowcharts, and other diagrams disclosed herein is an illustration of example approaches. Based upon design preferences, the specific order or hierarchy of blocks or operations in each of the processes, flowcharts, and other diagrams may be rearranged, omitted, and/or contemporaneously performed without departing from the scope of the present disclosure. Further, some blocks or operations may be combined or omitted. The accompanying method claims present elements of the various blocks or operations in a sample order, and are not meant to be limited to the specific order or hierarchy presented.

The present disclosure provides various different embodiments of in-process assembly error correction for assembly operations (including pre- and/or post-assembly operations). It will be appreciated that various embodiments described herein may be practiced together. For example, an embodiment described with respect to one illustration of the present disclosure may be implemented in another embodiment described with respect to another illustration of the present disclosure.

The present disclosure is provided to enable any person skilled in the art to practice the various aspects described herein. Various modifications to these exemplary embodiments presented throughout the present disclosure will be readily apparent to those skilled in the art, and the concepts disclosed herein may be applied to other techniques for printing nodes and interconnects. Thus, the claims are not intended to be limited to the exemplary embodiments presented throughout the disclosure, but are to be accorded the full scope consistent with the language claims. All structural and functional equivalents to the elements of the exemplary embodiments described throughout the present disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A method of robotic assembly of parts, the method comprising:
obtaining a target arrangement of the parts of the assembly, wherein the target arrangement includes a first target position of a first part, a second target position of a second part, and a third target position of a third part;
robotically joining the first part and the second part based on the first target position and the second target position in the target arrangement to obtain a first subassembly of the assembly, the first subassembly having a first physical arrangement, wherein the first physical arrangement includes the physical arrangement of the first and second parts after joining;
fitting the first physical arrangement to the target arrangement to obtain a fitted first physical arrangement; and
robotically joining the first subassembly and the third part, wherein the first subassembly is arranged in the fitted first physical arrangement, and the third part is arranged in the third target position in the target arrangement.

2. The method of claim 1, wherein the target arrangement further includes a fourth target position of a fourth part, and robotically joining the first subassembly and the third part obtains a second subassembly of the assembly, the second subassembly having a second physical arrangement, wherein the second physical arrangement includes the physical arrangement of the first, second, and third parts after joining, the method further comprising:
fitting the second physical arrangement to the target arrangement to obtain a fitted second physical arrangement; and
robotically joining the second subassembly and the fourth part, wherein the second subassembly is arranged in the fitted second physical arrangement, and the fourth part is arranged in the fourth target position in the target arrangement.

3. The method of claim 1, wherein fitting the first physical arrangement to the target arrangement includes performing a best-fit correction.

4. The method of claim 3, wherein performing the best-fit correction includes determining a difference in position between each of a plurality of corresponding pairs of same features of the first physical arrangement and the target arrangement, and minimizing an error based on the differences in position.

5. The method of claim 4, wherein minimizing the error includes minimizing a sum of the squares of the differences of position.

6. The method of claim 1, wherein fitting the first physical arrangement to the target arrangement includes
determining a difference between a first join position of the first part and a first target join position of the first part, and
determining a second target join position at which to join the third part with the first part based on the difference.

7. The method of claim 1, further comprising:
determining a set of parts associated with the assembly, wherein the set of parts includes the first part, the second part, and the third part;
determining dimensional information of each of the first, second, and third parts, and
determining the target arrangement based on the dimensional information.

8. The method of claim 1, further comprising:
determining, prior to joining the first subassembly and the third part, an interference between the first subassembly and the third part; and
adjusting the fitted first physical arrangement if the interference exceeds a threshold.

9. The method of claim 8, wherein the interference includes a portion of the first subassembly contacting a portion of the third part.

10. The method of claim 9, wherein the interference is determined further based on a tolerance of a joint between the third part and the first part.

11. The method of claim 1, further comprising:
measuring a first part position of the first part and a second part position of the second part based on a set of key product characteristics associated with the first part and the second part,
wherein fitting the first physical arrangement to the target arrangement is based on the first part position and the second part position.

12. The method of claim 11, wherein the key product characteristics include at least one of a tolerance associated with a joint included in the assembly, a clearance associated with the assembly, or a surface profile associated with the assembly.

13. A system configured for robotic assembly of parts, comprising:
a computing system configured to obtain a target arrangement of the parts of the assembly, wherein the target arrangement includes a first target position of a first part, a second target position of a second part, and a third target position of a third part; and
at least two robots configured to:
robotically join the first part and the second part based on the first target position and the second target position in the target arrangement to obtain a first subassembly of the assembly, the first subassembly having a first physical arrangement, wherein the first physical arrangement includes the physical arrangement of the first and second parts after joining, and
robotically join the first subassembly and the third part, wherein the first subassembly is arranged in a fitted first physical arrangement, and the third part is arranged in the third target position in the target arrangement, wherein
the computing system is further configured to fit the first physical arrangement to the target arrangement to obtain the fitted first physical arrangement.

14. The system of claim 13, wherein the target arrangement further includes a fourth target position of a fourth part, and the robotic join of the first subassembly and the third part obtains a second subassembly of the assembly, the second subassembly having a second physical arrangement, wherein the second physical arrangement includes the physical arrangement of the first, second, and third parts after joining, the computing system further configured to:
fit the second physical arrangement to the target arrangement to obtain a fitted second physical arrangement; and the at least two robots further configured to:
robotically join the second subassembly and the fourth part, wherein the second subassembly is arranged in the fitted second physical arrangement, and the fourth part is arranged in the fourth target position in the target arrangement.

15. The system of claim 13, wherein to fit the first physical arrangement to the target arrangement, the computing system is configured to perform a best-fit correction.

16. The system of claim 15, wherein to perform the best-fit correction, the computing system is configured to:
determine a difference in position between each of a plurality of corresponding pairs of same features of the first physical arrangement and the target arrangement, and
minimize an error based on the differences in position.

17. The system of claim 16, wherein to minimize the error, the computing system is configured to minimize a sum of the squares of the differences of position.

18. The system of claim 13, wherein to fit the first physical arrangement to the target arrangement, the computing system is configured to:
determine a difference between a first join position of the first part and a first target join position of the first part, and
determine a second target join position at which to join the third part with the first part based on the difference.

19. The system of claim 13, wherein the computing system is further configured to:
determine a set of parts associated with the assembly, wherein the set of parts includes the first part, the second part, and the third part;
determine dimensional information of each of the first, second, and third parts, and
determine the target arrangement based on the dimensional information.

20. The system of claim 13, wherein the computing system is further configured to:
determine, prior to joining the first subassembly and the third part, an interference between the first subassembly and the third part; and
adjust the fitted first physical arrangement if the interference exceeds a threshold.

21. The system of claim 20, wherein the interference includes a portion of the first subassembly contacting a portion of the third part.

22. The system of claim 21, wherein the interference is determined further based on a tolerance of a joint between the third part and the first part.

23. The system of claim 13, wherein the computing system is further configured to:
measure a first part position of the first part and a second part position of the second part based on a set of key product characteristics associated with the first part and the second part,
wherein the fit of the first physical arrangement to the target arrangement is based on the first part position and the second part position.

24. The system of claim 23, wherein the key product characteristics include at least one of a tolerance associated with a joint included in the assembly, a clearance associated with the assembly, or a surface profile associated with the assembly.
